(19) United States
(12) Patent Application Publication
(10) Pub. No.: US 2009/0106100 A1
(43) Pub. Date: Apr. 23, 2009

(54) Method of digital good placement in a dynamic, real time environment

(75) Inventor: Alex Mashinsky, Memphis, TN (US)

Correspondence Address: COHEN, PONTANI, LIEBERMAN & PAVANE LLP, 551 FIFTH AVENUE, SUITE 1210, NEW YORK, NY, 10176, US

(73) Assignee: Governing Dynamics LLC, New York, NY (US)

(21) Appl. No.: 11/918,697

(22) PCT Filed: Apr. 19, 2006
(86) PCT No.: PCT/US2006/014597

§ 371 Date: Oct. 17, 2007

Related U.S. Application Data
(60) Provisional application No. 60/674,703, filed on Apr. 26, 2005.

(51) Int. Cl. G06Q 30/00; G06F 17/30; G06F 7/08; G06Q 10/00

(52) U.S. Cl. 705/14; 705/10; 707/5; 705/34; 705/80; 705/26; 707/E17.017

(57) ABSTRACT

A method and system for advertising selection, placement management, payment and delivery in a dynamic, real-time environment wherein the production, listing, procurement, payment, real time management, re-allocation and financial settlement of all types of digital advertising mediums, with optional automated delivery for advertisement and messaging for such ads is performed. The planning, purchasing, delivery and payment for on-line and traditional media advertising is automated, standardized and tracked across multiple mediums, such as TV, Internet, satellite, radio, wireless telephone, outdoor screens, and other digital mediums that display dynamic content. As a result, transparency and discovery of price, performance and availability segmented by specific markets and customer profiles for specific products is achieved. A buyer/seller real time feedback is provided to allow both buyers and sellers to dynamically change existing ads, ad space, prices, etc, in a real time environment based on real time sale/conversion feedback.

### CROSS REFERENCE TO RELATED APPLICATIONS

This application claims priority from U.S. Provisional Application Ser. No. 60/674,703, filed Apr. 26, 2005.

### FIELD OF THE INVENTION

The present invention relates real time delivery of digital goods in a commerce environment. More particularly, it relates to a method and system for selection, placement management, payment and delivery of digital goods, including advertising media space, in a dynamic, real-time environment.

### BACKGROUND

In the traditional advertising structure, advertisers employ agencies to plan advertising strategy, create content and secure media space according to desired demographics as well as other parameters. Many media companies employ media representatives to extend their geographic sales coverage and client base. Here, transactions are finalized well before the actual advertisements are delivered and aired. This current advertising media transaction process has several inefficiencies. For example, the buyers and sellers of advertisements are geographically fragmented, the marketplace is extremely fragmented, the implementation of the transaction is time and labor intensive, the adoption and application of new technologies is slow, there is an inability to track and correlate ad results, there is a large spread between different types of media and prices in different markets, there is an inability to obtain the effectiveness of specific media to specific products at specific times, and there is a fundamental lack of flexibility in changing or adopting media buying to market trends and feedback.

Quite often, purchasing the right media for an advertising campaign presents a considerable challenge. Most advertisement space medium purchasers require substantial future planning and advanced implementation. In addition, determining and designing the right advertising campaign takes years of experience, industry specific expertise, long-term planning and effort, all of which have permitted Ad agencies to charge 15% or more for media placement services. However, the advent of digital production, delivery and distribution has created new opportunities for a much more flexible and liquid advertising marketplace.

The global economy is becoming more and more integrated. As a result, access in real time to the latest relevant information has become critical to doing business, such information can make the difference between successful companies and unsuccessful companies that lag behind with respect to their ability to react to changes in the marketplace. Presently, the majority of competitive information is delivered by specialty research and financial firms via proprietary subscription to many fragmented networks, such as Bloomberg and Reuters. This information is used primarily by industries, such as the financial markets, which rely on this information. In addition, it is provided without any filtering, and it is up to the user to find relevant data in the vast quantity of publications, such as daily news releases and press announcements.

The integration of the global economy is most noticeable in the form of the global network of computers commonly referred to as the internet. The internet has grown to such a large extent that it now contains several billion addresses. Each one of these addresses may have an associated website and content which changes without prior notice. Alternatively, websites may be dynamically linked to other sites or to devices via web services or xhtml links. Such changes in content and linkage may occur several million times a day. Oftentimes, these “postings” and changes are initiated by third parties. The search engines and other services looking for such changes may not always locate or index the sites. As a result, the web users may not be aware of postings or changes to these sites.

The increasing need for reliable and up to the minute search, price and news information has made it increasingly difficult to find and rank (e.g. by most recent order) new information one is looking for in the ever growing global Internet. For example, most conventional search and news gathering engines focus on crawling and indexing an existing and mostly static inventory of websites. Due to the sheer size of the internet, there is a growing lag between the time a new or existing site or content of the site is published and the time such information becomes available as indexed data on popular search engines. Although most information on the web is free, many subscribers and advertisers are willing to pay for such information if it can be delivered in a “ranked and indexed” format to each relevant subscriber based on queries supplied by the requestor of the information.

With the age of the internet, the advertising industry is fast growing and changing even faster. Worldwide web advertising revenues were projected to grow by 40% and reached nearly $12.5 Billion in 2005.

Technological advances have effected major changes in the advertising industry. For instance, the mobile phone is one of the latest interactive mediums that can be used to perform location-specific targeting. More recently, however, other multiple media types, such as web sites, blogs, search engines, interactive TV, Web TV, outdoor digital billboards, satellite radio, the Internet, are being used to provide a more effective advertising medium. Consequently, these forms of multimedia applications are transforming mass media into new, one-to-one forms of advertising. The emergence of personal Web TV service will change viewing habits whereby prime time and channel branding will become less relevant. Commercials will be eliminated unless they are made compelling to individual viewers.

As the majority of devices connected to the web migrate from being dominated by PCs to wireless handheld devices the context and form of search and related services need to change to accommodate the special location and size and space limitations of these devices.

Based on the foregoing, there it is clear that there is a lack of liquidity since such large part of the serving is done via GOOGLE and YAHOO. These engines also use many other networks to deliver ads and aggregate inventory so there is much duplication in serving ads and counting effective return on investment (EROI).

Many web sites (Publishers) are using networks like GOOGLE and DOUBLE-CLICK as market makers and let them negotiate manage and pay for distribution and transaction management. In doing so publishers lose large parts of their potential income.

Many broker networks are daisy chained to one another which creates latency in delivering ads to the publishers on time due to the fact that such ads have to transit multiple ad servers on their way to the user's browsers. Such an ad service network reduces effectiveness and limits the number of connections between different networks because they cannot serve on time.

The current existing networks have no way to block or manage advertising creative and/or manage the delivery type or content.

Publishers currently prioritize inventory sale by matching their internal systems with what is offered by networks and direct advertisers, such matching is mostly manual and since it covers millions or billions of daily hits is not granular and not dynamic. Because of this large amounts of revenues are wasted since the inventory is not sold to the best advertiser and the advertiser is not getting the best ECPM since the systems don't adjust dynamically.

There are currently no systems that collect and add advertising or relevant information to such new information and then disseminates it to interested parties and provides for market based pricing for such advertising services. Existing networks, and systems that are currently available do not allow buyer and sellers to share information with each other or the networks. In addition, the networks such as GOOGLE, do not share any information with the buyers and/or sellers.

It is therefore apparent, there is a need for a method and system for implementing a solution in which a web matching engine provides some transparency and enables real time trading of ad capacity, keywords, banners and other forms of media among buyers and sellers.

It is further apparent that there is a need for a method and system for providing a matching mechanism that not only enables the matching of buyers and sellers of advertising media space, but also enables the matching of buyers and sellers of any type of digital goods.

### SUMMARY OF THE INVENTION

Although described herein in the context of advertising space or advertising media space and the matching of the buyers and sellers of the same, those of skill in the art will understand that the web matching engine of the present principles combined with a system to effect the delivery of such matched goods from the buyer to the seller or vice versa, and the operations associated there with and as described herein, are equally applicable to the sale and delivery of any type of digital goods over digital networks. Examples of digital goods include, advertising space, e-books, videos, pictures, music, ring tones, etc. and any other good or service that can be provided in a digital medium.

The present principles over come the shortfalls of the existing networks and systems by allowing buyers, sellers and the third party networks to share information relating to sales, conversions, products categories, etc. and thereby allowing each party in the transaction chain to optimize their monetization and maintain additional controls in a real time environment. For example, the buyers will be able to find the best prices for the products or services they seek, and further be able to dynamically adjust their budget allocations or desired category within which they are purchasing based on real time feedback provided by the system. In the same manner, the sellers would have the same advantages of real time feedback for digital goods being offered and the management of their pricing, availability, etc. can be dynamically changed. It is this sharing of transactional information (from any source the buyer and seller can provide) that provides the higher level of management at the buyer and seller level, while allowing each party in the transactions to optimized their monetization throughout the entire process.

The present principles relate to a method and system for advertisement selection, placement management, payment and delivery in a dynamic, real-time environment in a an ever changing market place for the production, listing, procurement, payment, real time management, re-allocation and financial settlement of all types of digital advertising mediums, with optional automated delivery for advertisement and messaging for such ads and goods. The planning, purchasing, delivery and payment for on-line and traditional media advertising is automated, standardized and tracked across multiple mediums, such as TV, Internet, satellite, radio, wireless telephone, outdoor screens, and other digital mediums that can display dynamic content. As a result, transparency and discovery of price, performance and availability segmented by specific markets and customer profiles for specific products is achieved.

In order to alleviate the growing problems associated with the increase of on-line mediums and the fragmentation of the on-line advertising industry, the method and system of the present invention ranks and qualifies all of the different sources of venues and advertisers, and accurately tracks and ranks their effectiveness in translating ad dollars to orders and revenues segmented by industry and by product and service type. The on-line advertising industry offers an unparalleled ability to track and target advertising and to also allow advertisers to closely interact with end users. The system uses all such tracking information collected from buyers and sellers and third parties in a transparent way which enables all parties involved to use the data to perform better matches between buyers and sellers with higher optimization and bottom line results for both sides. Currently there is a lack of transparency of matching information since due to the fact that largest networks like Google do not publish or make their transaction and conversion information available. In addition, there is a fragmentation of the on-line advertising industry. As a result, great spreads exist between the publisher's price of a spot Ad and the final price an ad agency or advertiser will pay for it. This has generated a need for an open market that can be used to determine the market value of any ad, medium or available digital goods. Here, a web matching engine is used to collect and match trades, execute trades and deliver ads, and settle trades and collect market data.

The system and method of the present principles permits sellers of ad space (or digital goods) to more effectively manage their inventory by deciding if it should be routed to their direct clients, the market place or networks such as GOOGLE fill empty spots up to the last minute before providing the ad space to the general public, as opposed to selling ad space months in advance. In accordance with one embodiment, the web matching engine develops an active primary and secondary market. As a result, better segmentation and price discovery for each medium is achieved because an ad will show the market view of the pricing power of each spot, ad, and website. Moreover, the web matching engine permits the tracking of each advertising campaign, as well as the effectiveness of the campaign across multiple mediums.

The web matching engine of the present principles, avoids the daisy chain connect and latency problems by directly connecting all such parties via a single central matching engine and by allowing ads to be served via the advertisers server, a web matching engine primary database or have ads resident on a publisher's database to avoid latency. The web matching engine collects transaction information through its own and other reporting means (e.g., third party agencies) and maintains a permanent billing relationship with all participants so it can provide its services and guarantee payments and collections to hundreds of thousands of publishers and advertisers which do not have any financial relationships.

The web matching engine of the present principles will allow users to block and/or manage advertising creatives and/or manage the delivery type or content by automatically ranking creatives (e.g., as R or PG13) and let both sides (i.e., sellers and buyers) manage the same.

The web matching engine of the present principles significantly automates the publisher inventory prioritization sale problems of the prior art by automating this otherwise antiquated manual internal sorting and prioritization job network program. The web matching engine of the present principles allows advertisers to provide their inventory and pricing directly to the web matching engine, which in turn automatically determines and prioritizes the publishers inventory sale on the web matching engine network in conjunction with their own internal inventory and networks. As such, an automated redirecting takes place by the matching engine to provide publishers with the best monetization for their inventory.

The web matching engine creates a transparency between the visitors to search engines, billions of web sites and blogs on the Internet and their conversion, and the ability to match the ads most appropriate for each site and medium and convert them to sales. As a result, the search engines, the web sites and blogs are able to obtain much higher rates for their click through ads. The web matching engine permits advertisers to charge whatever they desire, and as long as the prices are competitive their ad leads will result in sales. In addition, the advertisers will retain the full value offered by the seller minus the transaction fee. As a result, aggregators which currently dominate web advertising are replaced with an intermediate mediator which permits automated optimized spending of ad dollars in the most efficient way based on real results.

The web matching engine of the present principles can operate in several levels based on the customers needs, some examples of such operations are listed below:

1. Just match potential publishers and Advertisers;

2. Match and connect electronically;

3. Match connect and serve the ads;

4. Match connect, serve and bill;

5. Match connect serve, bill and collect; and/or

6. Automatically match, connect, bill, serve, measure, publish transaction information, change allocations, start over and at the end of the period, collect payments.

In addition the web matching engine includes a Buyer and Seller transaction feedback loop which will rank the relationship and experience of different members with each other.

Other aspects and features of the present principles will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is an exemplary block diagram illustrating the interaction between different elements of the web matching engine in accordance with an embodiment of the present principles;

FIG. 2a is an exemplary schematic block diagram illustrating the processing of information collected by the web matching engine of FIG. 1;

FIG. 2b is a plan view of the different operating layers of the web matching engine according to an embodiment of the present principles;

FIG. 2c is an exemplary schematic block diagram illustrating the interaction between different elements of a web matching engine in accordance with the present principles;

FIG. 2d is an exemplary schematic block diagram illustrating the processing of information collected by the web matching engine of FIG. 2c;

FIG. 3 is a flow chart illustrating exemplary steps of the matching method of the present principles;

FIG. 4 is a flow chart illustrating alternative steps of the method in accordance with the present principles;

FIG. 5 is a schematic block diagram of the system in accordance with the present principles;

FIG. 6 is a flow chart illustrating a general overview of the steps of the method in accordance with the present principles;

FIGS. 7(a) and 7(b) is a flow charts illustrating steps associated with the activities of a buyer up to the transmittal of advertisements from the buyer to the central clearing facility of FIG. 5;

FIG. 8 is a flow chart illustrating the steps associated with the activities of a seller up to the transmittal of the advertisement space or package offers from the seller to the central clearing facility of FIG. 5;

FIG. 9 is a flow chart illustrating the steps associated with receiving, processing and matching buyer orders and seller offers at the web matching engine of FIG. 5; and

FIGS. 10(a) thru 10(e) is a flow chart illustrating the steps associated with the decision-making that is performed by the buyer after the web matching engine has located at least one match between the order from the buyer and at least one offer from the seller.

### DETAILED DESCRIPTION OF PREFERRED EMBODIMENTS

There are different legal and pricing structures for advertising around the world. As result, the present principles provide a system and method for permitting the placement of digital goods, and in a particular embodiment, advertising media space globally. In accordance with the same, the web matching engine manages the system so as to control what type of content and pricing is being offered to advertisers while also matching the content to restrictions that sellers may institute. Here, geographically segmenting the advertising mediums and markets permits a market-by-market ad placement and budget management.

Many ad agencies serve the function of selecting, contracting and paying for media bought from many sources. Such agencies serve to aggregate many clients and have a single interface and payment source for the seller of the ad space. The web matching engine of the present principles operates such that the requirement for an ad agency is eliminated. The matching engine also eliminates the need to work with networks like Double Click or Google by finding and matching advertisers and publishers and eliminating any middle men. That is, the web matching engine serves the same function as an ad agency and networks at lower fees. However, the matching engine aggregates a greater number of buyers and sellers and provides centralized settlement and tracking discovery of effectiveness on behalf of many more buyers and sellers. In addition, the web matching engine ensures that funds are collected, provides for dispute resolution, as well as historical data on spending trends and pricing data. Data about the market can be collected, sorted and sold to third parties. In one embodiment, the web matching engine guarantees payments and eliminates bad debt for sellers.

In another embodiment, the web matching engine operates to improve the cash flow of a seller by allowing them to offer pre-payment for a discount or sell inventory in advance for an extended period of time, as well as allow buyers to assume the risk associated with fluctuating prices for such ads. As a result, a secondary market is provided in which trading for such a capacity occurs, either in the same or a separate market place. Ad inventory can be aggregated package and securitized on financial markets to provide liquidity and monetization of inventory for publishers. Data about the market can be collected, sorted and sold to third parties. In accordance with one embodiment, advertisement space buyers are permitted to decide whether to enter long and/or short-term commitments for advertising space with more ease, and then easily sell those “ad spots” in the secondary market if budgetary or advertising needs change. In such a market, the prime inventory holders will be able to obtain a better value for their inventory by allowing buyers to eliminate the risk associated with a purchase decision.

In accordance with other contemplated embodiments the web matching engine includes a clearing facility that collects buy orders from traditional on-line and media buyers, and obtains different types of advertising space inventory from on-line and traditional media sellers. Here, each selling party is permitted to register in an on-line site, describe the nature and demographics of their media and the price they are charging for different advertising slots, or provide such data from a reputable third party.

In addition, sellers are permitted to restrict certain content from being advertised due to competitive issues, legal issues or censorship issues. Here, for example, each buying party may register on the same site and specify key words, products, geography, budget and type of campaign being sought for the duration of the campaign, the markets to be covered and the demographics of the people buyers are trying to reach within a certain budget. The web matching engine then processes such requests and displays the best matches to the buyer based on current prices and orders with advertisement spaces offered by sellers based on historical and real-time conversion results which were provided to the matching engine. Such a match may be based on a buyer's need, having designated the lowest price per viewer. Alternatively, the match may be based on the highest conversion rate for each dollar spent on a specific day.

In accordance with the contemplated embodiments of the present invention, sellers with “virtual inventory” can emerge. For example, a seller with a virtual inventory would trade in future capacity much in a manner that traders trade stocks or bonds. Here, a seller would buy long-term ad contracts and sell them as short term multiple contracts or package them with other types of media and securitize the contracts or the cash flow associated with the ad contracts. Sellers may package many such contracts and sell them as a security or bond to others buyers with the matching engine serving as the market place to price trade and settle such transactions.

It is possible for a specific seller to be unable to fill all of the buyer's budget or conversion needs or parameters, either by virtue of media space availability or by click through price, or the like. As a result, the web matching engine is configured to provide an alternate match in real-time to the next seller's available media, and so on until the budget on the buy order has been fulfilled. The match is then sent to a buyer who is then permitted to view the proposed distribution of his budget over the media in real-time and can decide to continue to purchase, buy an option for future use or simply reserve the capacity to do so under certain terms or conditions. Alternatively, the buyer may place limit orders that will automatically execute his purchase orders through the budget allocation manager.

When purchase orders are placed or executed, the web matching engine may instruct the ad server to deliver the appropriate ad from the buyer's server or the web matching engine database to the seller's server for presentation to the next viewer for advertising. Such ads may be resident on the publishers Ad server to minimize latency. For instance, the seller may guarantee that a certain show's ratings or web limits will not be below a certain level. The web matching engine then “books” the transaction and prepares to transfer some or all of the funds between the buyer and the single or multiple sellers with which the buyer previously entered into a purchase contract with. The web matching engine delivers the advertisements to the different advertising media for the advertisements to be aired in accordance with the agreed upon purchase plan. The web matching engine then measures in real time the performance of the media, and if the performance of the media falls below predetermined expectation levels, then the matching engine may replace the under performing ads in real-time with other ads that require lower conversions at a lower price. Unlike the systems used by GOOGLE or YAHOO, the web matching engine of the present principles does not display a price. Rather, the web matching engine permits buyers and sellers to show their buy and sell orders so matches can be made directly with full disclosure of terms and historical performance. In addition, the web matching engine does not keep the spread between buy and sell orders in the same manner as the GOOGLE system. Rather, a full price discovery is provided to the buyers, after which transaction and settlement fees are charged.

In accordance with the present principles, measurements are performed to collect information from multiple sources to compile accurate conversion and exposure information about buyers. The multiple sources may include third party rating agencies, pricing and buyers supply chain software, website tracking software, third party inventory, conversion and trading orders, increase in web visits or call center calls over historical levels, conversion results for all buyers in the same industry across many buyers categorized by media types, dates and geography and other information relevant to buyers making a buying decision and sellers making inventory decisions.

Data from the supply chain and customer relations management (CRM) systems of a buyer can be linked to the web matching engine such that real-time feedback of actual orders can be correlated to the media buys. As a result, the buyer's budget with the web matching engine is optimized. In this case, the data can be provided periodically or it can be integrated via web services to the central clearing facility for real-time optimization. In addition, the method of the present principles permits sellers to provide different tracking agencies with their respective data to demonstrate improved ranking or performance. Here, results from sales outlets are provided and fed to databases to compare the promised level of performance to the actual level that is achieved by the ad media. If the performance of the ad media is below the expected level, the web matching engine may redirect future budgets spending to other sources on behalf of its buyers. Alternatively, the web matching engine may use a portion of the funds that are deposited by a buyer to purchase other media. In addition, a refund can be made to the buyer in accordance with a prior agreement.

On the other hand, if the results of the ad media exceed the expected level, the central clearing facility may charge the buyer a premium, based on a contractual agreement between the parties executed at the time of sale. In accordance with the present principles, data is collected for all types of ads. As a result, any advertiser can view projected conversion rates and the efficiency of spending his budget dollars on a specific medium on a specific day. Here, the web matching engine then displays the real-time transacted data segmented by industry, category, product, service, conversion, and other categories as they correlate to each media type and inventory profiles from different publishers on the web to permit other buyers and sellers to adjust their pricing and buying needs, as well as the price that is paid for each ad, page on a web site or other digital medium.

The web matching engine of the present principles permits different types of publishers and sellers to compete on price/performance against each other in a single market space, on each category and spot where the results of the dollars spent can be immediately tracked and converted into additional buys or redirected to other forms of advertising. Here, the web matching engine maintains a detailed database that includes the prices of all forms of ads for all types of advertising channels, voice and data networks and for all types of media, while keeping the identity of potential buyers and their specific prices and profile needs anonymous if they wish to be. In addition, the web matching engine displays the last price paid for such media, arranged by different product categories. Moreover, the web matching engine shows all buy and sell orders to users for each ad or each buy order and shows matched orders and their prices.

The method of the present principles seeks to more accurately match different buyers to the ad space that provides buyers with optimal sales results. As a result, the web matching engine is configured to provide the optimal match that will minimize buyer spending, while at the same time maximize the revenues generated by sellers. Here, it is market price dynamics that dictate whether prices for ads, webs and blogs fluctuate, which will set the specific price for a specific day for the word car on a specific search engine or web site registered with the web matching engine. In addition, the web matching engine is also configured to provide customized direct marketing, which is implemented via different media applications. As a result, buyers and sellers are permitted to focus their advertising expenditures on specific venues in proven segments which have potential customers and accurately track the response and conversion rates of these expenditures.

In general, sellers of ad space compete among themselves and media types, such as the Internet, TV, radio or outdoor billboards. Conversely, buyers compete among each other in the same category and with other different product categories that may prove more effective at certain times on certain types of ad media. All such information is published or purchases by buyers and sellers so they can optimize their trading and generate better conversions or monetization of inventory. Such optimization can be done manually or by submitting all such information to the dashboard and budget allocation manager by including their own internal market data as well as third party performance data for other network buyers and sellers guaranteed optimization. As a result, buyers may agree to pay more for a specific media type on a specific day, set time of day, etc. Initially, the web matching engine matches and transacts on such data. In addition, the web matching engine of the present principles is configured to broadcast or stream advertising content in any format to and via any desired network to third parties on pre-agreed contractual terms.

On the web, the placement of ads is managed by large network companies, such as GOOGLE, YAHOO or Microsoft, which are adverse to the interests of advertisers or spread between buyers and sellers. These companies are driven by the sole objective of optimizing their respective profits and operate as black boxes and actually shield market information from all parties so as to optimize their profit margins. Unlike GOOGLE or YAHOO!, the web matching engine of the present principles is not a black box against which an advertiser bids on one side and on the other side, publishers bid against each other. Rather, it is a facilitator that permits market and ratings data to dictate in real-time price and availability of media segments, banner space or keywords and their relevant pricing on a certain day and for a certain media type or certain day and time.

The system and method of the present principles is directed to capitalizing on the new technologies associated with providing a solution to creating a flexible, dynamic, fluid real-time marketplace for advertising. The system provides sellers with direct access to customers. In addition, the web matching engine permits the maximization of inventory value and eliminates time or geographical constraints associated with ads or exposure coverage. On the one hand, the present method and system permits a seller to enter geographic markets that may possess different conversion prices or costs merge each country or region. On the other hand, the present method and system expands the number of ad choices available to buyers. As a result, the choices and selection for purchasing opportunities is maximized.

Furthermore, buyers are provided with real-time access to market prices and media availability in each geographic market covered by the web matching engine. Here, the web matching engine reduces transaction costs for both buyers and sellers and increases the overall dollars spent by allowing smaller companies and new types of products to advertise and use mediums that were previously unaffordable or were previously not cost effective. The system and method of the present principles provides for centralized and automated advertisement orders, order confirming, invoicing, reporting and billing for any buyer or seller. As a result, buyers and seller are permitted to enter into commerce with a large number of entities with relative ease, as well as without being exposed to the risks associated with bad receivables.

It is to be understood that the present principles may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present principles.

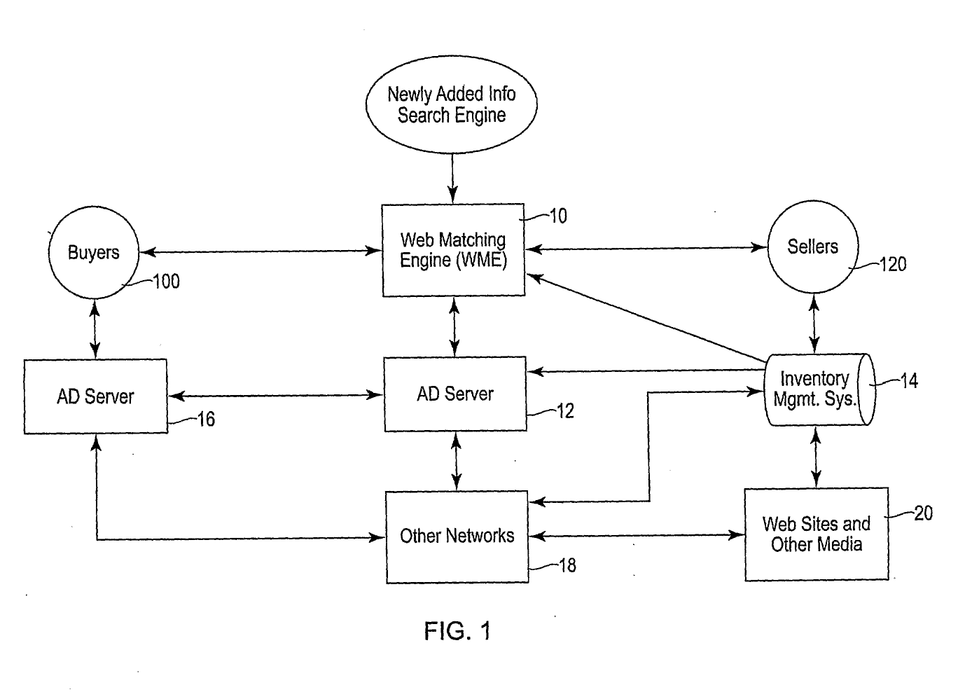

FIG. 1 is a high level block diagram illustrating the interaction between sellers and buyers with the web matching engine 10 in accordance with an embodiment of the present principles. In this example, the dynamic addition of newly added information is described. The newly added information, as referred to herein, is newly added information which is sent to subscribers of the matching engine, such messages being linked or encapsulated with ads from the WME and delivered via the ad servers.

The present system and method aggregates published data and collects RSS and other feeds from sites, companies and public information sources that do not publish their changes and additions, and processes the aggregated publications and data to be stored temporarily or indexed and stored permanently so such information can be matched to each of the search and profile query entries made by subscribers, buyers and third parties who are customers of the web matching engine 10. Subscribers who are interested in being informed about specific news or announcements and changes made on a specific subject or by a specific company may go to a website and request such notifications to be sent to them in a specific format and to a specific device, such as a computer, cell phone, personal digital assistant (PDA) or some other web enabled device.

In accordance with the present principles, web matching engine 10 receives newly added information and correlates that newly added information with the buyers 100 and sellers 120 requests via other programs. The buyers 100 are connected to a buyer ad server 16 which in turn is connected to the web matching engine ad server 12.

The sellers or publishers of new information have their own inventory/management system 14 that is in communication with the web matching engine ad server 12, the web matching engine 10 and other networks 18. These other networks 18 includes any non-internet based network, and may also include networks like GOOGLE, YAHOO or others. In addition, the inventory/management system 14 is connected to other websites/other media 20 which can include TV, radio, etc.

The buyer ad server 16 maintains storage of the buyers advertising purchases and purchase orders route plan, and also receives the feedback information from the web matching engine 10 to provide the buyer with real time conversion information relating to their advertising purchases. Sellers 120 have an inventory of ad space that is managed with the inventory management system 14. The inventory management system 14 is connected directly to the web matching engine, the web matching engine ad server 12, the other networks 18 and webs sites and other media 20. The inventory management system 14 allows the sellers 120 to monitor available media space they are selling in the various different categories of the same in substantially real time and direct their inventory to the network or system providing best monetization of their inventory.

As shown, the sellers 120 and the buyers 100 can be connected directly to web matching engine to enable sellers and buyers to bypass the automated system of the present principles and work directly with each other.

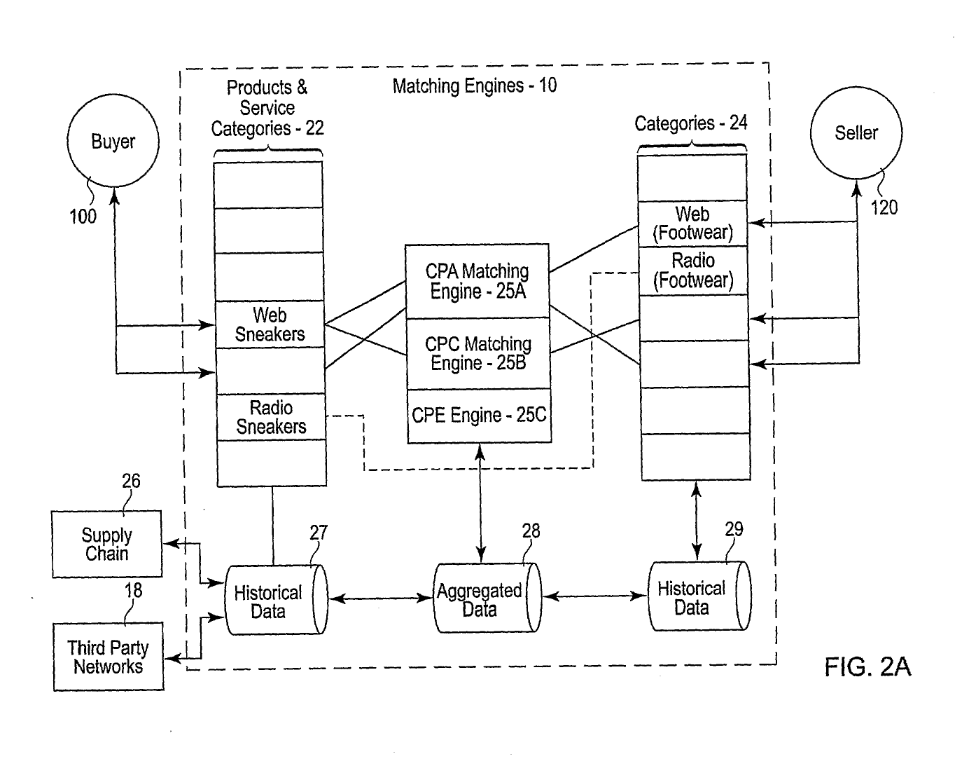

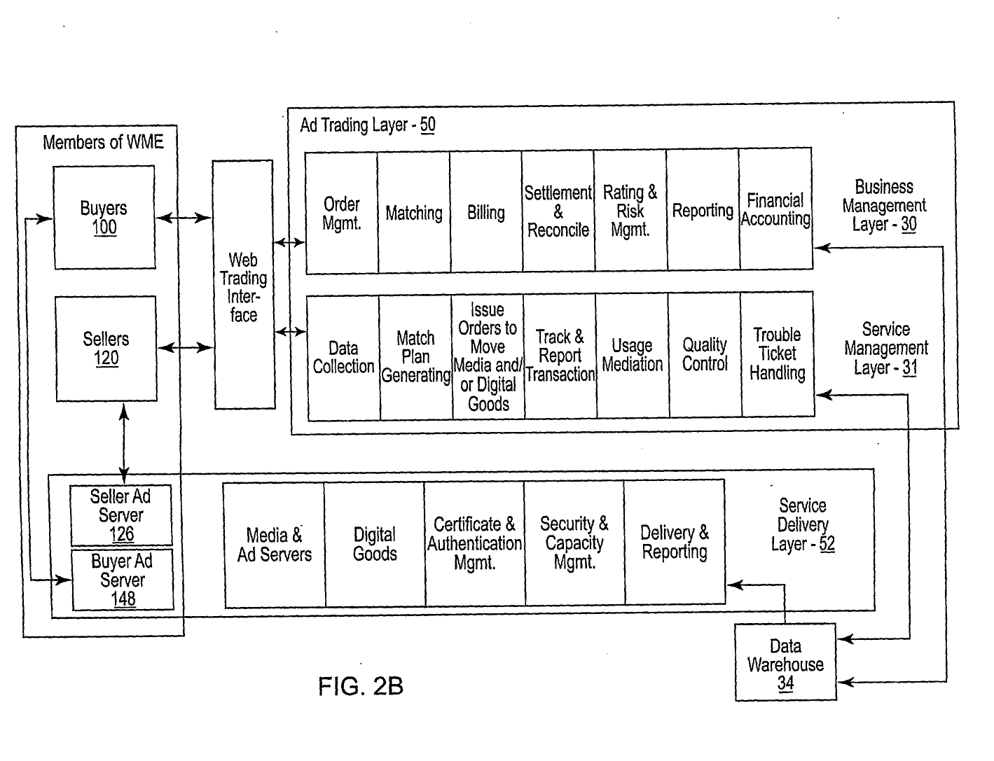

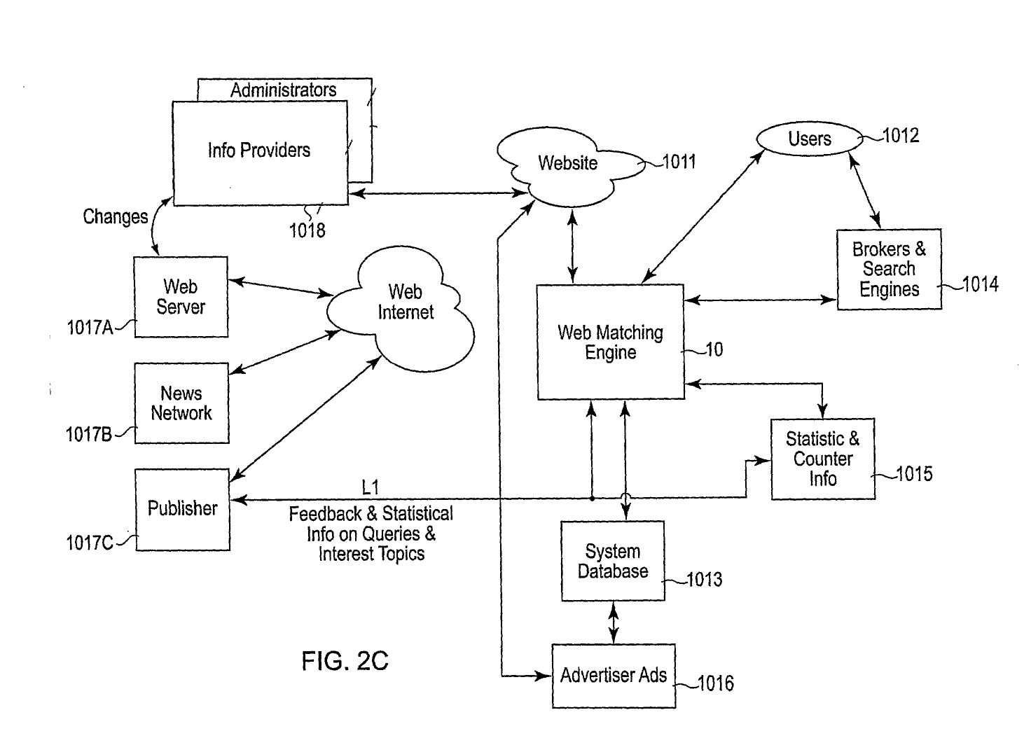

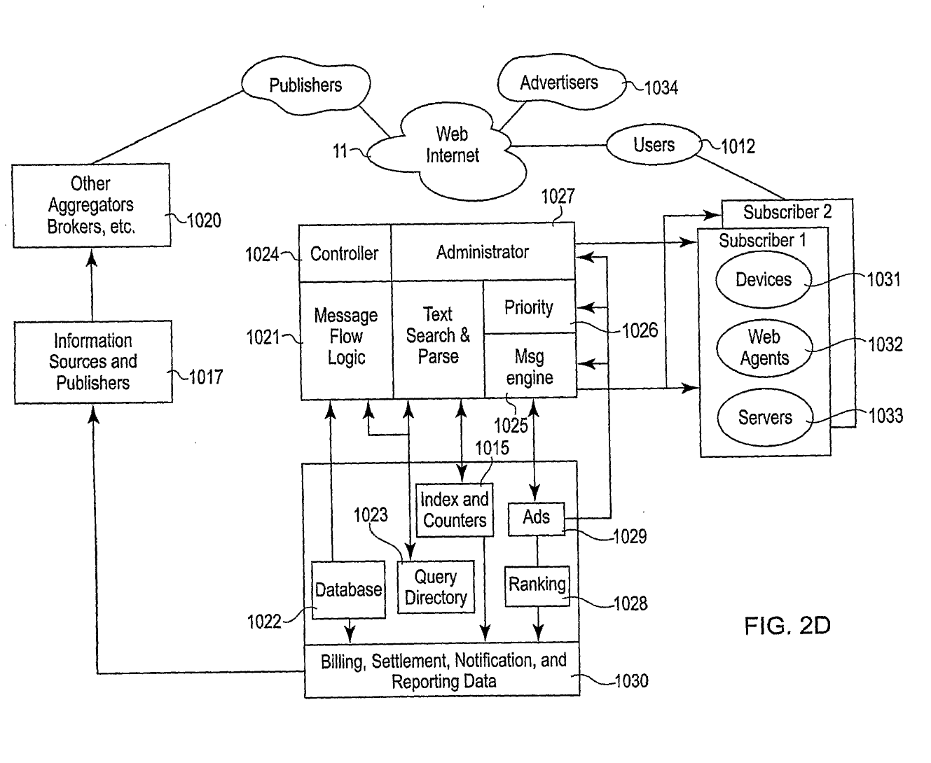

FIG. 2a shows a more detailed block diagram of the web matching engine 10 according to an embodiment of the present principles. In particular, this block diagram is an example of a comparison that takes place between one buyer and one seller for one particular category or group of categories relating to each on which a match in price and CPC, CPA, or CPM was established.

The web matching engine 10 is shown as having various matching engines 25. For example, a cost per acquisition (CPA) matching engine 25a, a cost per click (CPC) matching engine 25b and a cost per exposure (CPE) matching engine 25c. These matching engines are web based and are shown for exemplary purposes. Other types of matching engines can be added without departing from the spirit of the present principles. For example, the matching engine 25 can be one adapted to match the sale and purchase of digital goods on any digital network in accordance with the principles disclosed herein.

The web matching engine 10 of the present principles operates to collect and match advertising trades, execute the trades and deliver the ads, while also being capable of settling the trades and collecting the market data relating to the same. The data collected by the web matching engine 10 can come from its own activities based on subscribed buyers and sellers, it can come from third party networks 18, and/or any other source of marketing data that it can be connected to.

By way of example, and referring to FIG. 2a a seller 120 lists the categories 24 for which they want to compete or have media space available. For example, the seller 120 has media space on the web and on the radio for footwear related products. Buyer 100 inputs they are looking for space to market their sneakers, and in particular, they have expressed an interest in web and radio advertising. The web matching engine 10 now compares the buyers requests with the inventory of media space for each and every seller 120 that is part of (or subscribes to) the system of the present principles. In the present example, the buyer 100 will be presented with the CPA, CPC or CPE pricing options for the web advertising available from this particular seller and many others. By collecting relevant information from the historical databases 27, 28 and 29, the buyer will be shown CPA, CPC and CPE information related to the success and pricing levels available in the marketplace for their selection for their category. Buyers can then proceed to select and link to specific sellers or let the system manage such links for them automatically. In addition, the web matching engine 10 will also match this buyer with this seller for the requested radio ad. This matching may be more direct and does not include the web specific CPA, CPC or CPE type programs. Such transaction information will be recorded and used by others as a price and effectiveness reference for the product and category transacted.

The matching engine 10 includes buyer historical data 27 and seller historical data 29. The buyer historical data 27 obtains information directly from the buyer upon each transaction that took place for such media space, while at the same time compiling relevant information from a supply chain 26 and other third party networks 18 so the historical data can provide the buyer with a view of all the alternatives available to him including ones which are not available in the marketplace. The buyer and seller historical data 27 and 29 are aggregated 28 within the web matching engine so as to provide the engine with as much information possible when processing matches for buyer orders and seller media space and allow the matching engine to perform optimization of all options including internal inventory and third party networks. Such data is also used by bother parties to change pricing and category information to better compete with other sellers and buyers in the market place. By changing buyer minimum requirements and seller minimum pricing, better matches and higher revenues are generated.

According to one aspect of the invention, the web matching engine 10 may also utilize artificial intelligence (AI), user feedback, Digital Objects Identifier (DOI) links, web services, xhtml tags or other tools to enhance the ability to match the flow of information to the queries in the system, as well as to “self train” the system to permit buyers 100 to prioritize and focus their queries to relevant information aggregated by web matching engine 10. In general, comparison engines or other automated systems may contain millions of queries that access web matching engine 10 at any given time and during use. Such users or engines may generate a substantial revenue stream if their conversions ratio for goods and services are better than alternative web advertising systems providing enhanced matching services to their customers.

The web matching engine 10 of the present principles provides an alternative to the traditional methods of submitting information to the public, such as via a press releases or web sites. Typically, such information is submitted with the hope that people who receive the information will actually read it. According to the present principles, conventional systems are replaced by a system that gives publishers and sources of unique information a good reason to publish their data through the web matching engine, product announcements, pricing and promotional announcements, new prices, software or service releases can be directed to only interested parties. If content that matches the interests of subscribers is found, a function that is approved by the subscriber is performed. For example, the function may be providing a link about a press release to a specific set of subscribers who have indicated an interest in receiving such information or loading a demo of the program or service. The matching engine 10 can provide real time ranking info of other users so subscribers can make instant decision about their interest to buy or try the service.

In accordance with the present principles, continuous monitoring of millions of information sources can be achieved with minimal effort and very low cost by indicating certain keywords or subjects to the web matching engine 10 or other collection programs. Notifications can be sent almost immediately to a variety of communication devices, such as wireless devices, PDA's, computers, etc. In accordance with the present principles, the messages or services will appear in a variety of formats and will support existing standards and proprietary systems, such as email, instant messengers, Short Message Service (SMS) messages and Bloomberg terminals.

In addition, web matching engine 10 provides client software interface and personal web-logs which permit subscribers to manage their accounts, queries, budgets, profiles, historical events and prioritization that are stored in historical data database 27. Moreover, web matching engine 10 also synchronizes user storage devices with all relevant information that is found. As a result, the subscribers are continuously provided with the latest data about the topics they care about most, and can access them immediately on their device without the need to access the network or use their computers. Preferably, the subscribers are provided with up to 60 days of the latest information which may include voce video and data on their topics of choice which they may access locally without internet connections since the web matching engine synchronizes their data when they are available online.

Many websites do not allow crawlers or non-subscribers to access internal data. As a result, the majority of the information on the website is not accessible to search engines. In contrast, the web matching engine 10 of the present principles functions as a trusted partner in collecting, processing and notifying specific subscribers with specific information which otherwise would not be available. Here, the web matching engine 10 can also function as a clearing facility to process large numbers of transactions which require micro payments that would otherwise not be economical for any of the individual information sources to process. The matching engine can manage the login, security, and validation of subscriber information for millions of small publishers or information providers who may not have relationship with such clients but would like to charge for their service. In an embodiment of the present principles, web matching engine 10 manages and delivers advertising or competitive content on a publisher's original site when users utilize notifications by the web matching engine to link or visit the actual website of the publishers.

In another embodiment of the present principles, the flow of information is used to generate profits for originators of content, aggregators or traders of ad queries, subscribers and advertisers of the web matching engine 10. The matching engine provides for full transparency of pricing related to any buy and sell offer for keywords or event triggered ads. Such transparency dramatically reduces the need for aggregators such as GOOGLE, YAHOO and other search engines who use a system by which advertisers bid blindly for keywords without knowing what the market price is to reach a user interested in such keyword. Such bids which are subsequently translated into commercial listings provided side by side with the free search results generated by the search engines provide a very high margin for the search engine. However the providers of the information and the users of the search engines do not have a way to generate income or obtain a portion of the fees charged by the search engine. In addition, the ability of the buyers of the keywords to refine their “hits” is limited, because Google has limited knowledge about the person performing the search or his real intent to buy or engage in commerce.

In contrast, the web matching engine 10 of the present principles permits the publishers, aggregators, subscribers and the information providers to receive a portion of the fees charged by the web matching engine, as well as to obtain the true value of what buyers and sellers are willing to pay or be paid for certain listings or for performing specific transactions since the matching engine charges a transaction fee and not the margin between what it pays and what it collects from advertisers. Such full disclosure will immediately provide lower prices for advertisers and aggregate many users who will be happy to be paid for their daily queries. In another embodiment, the collection and sale of statistical and usage information about transactions conducted by the matching engine provides another source of revenue. Many sources including financial institutions and brokers will pay for such information since it can be used as an early indicator to show trends with products, companies, prices and services. Here, web matching engine 10 makes all such information available to third parties for a fee.

In accordance with the present principles, an expanded list of categories that subscribers have interest in is managed, and proactive notification and formatting of such data is provided to buyers 100 whenever a topic appears on the Internet in the context requested by the subscriber. As a result, advertisers and businesses selling digital goods are permitted to more accurately target potential customers. In addition, the customization of when and what to send to each subscriber is performed. Different messages and different prices are also sent based on the specific events generated by third parties or the web matching engine 10. For example, the system of the present principles permits an advertiser to indicate to the matching engine 10 that an ad about life insurance should be sent to all subscribers who have entered the word “disaster” only when news about a disaster event passes through the web matching engine. Similarly, a manufacturer may request to send a specific ad with a specific price each time a news release or posting about a product from a competitor passes through the web matching engine. Here, the notice may be sent only to a specific set of subscribers which have provided a profile accepted by the manufacturer.

Web matching engine 10 also uses a combination of events to generate leads. For example, a person moving from one home to another will indicate to the web matching engine he is interested in receiving information pertaining to his new location. Here, a list is created of competitive offers from movers, mortgage banks, insurance agents, local merchants and other relevant things the subscriber may need but may not think of. The matching engine may also permit advertisers to target people who have completed a series of actions and select only those for a special promotion or for target marketing. The subscribers may request the matching engine to always provide competitive information for any offer made by an advertiser as a way to use the web matching engine to validate the value of a specific offer.

In another embodiment of the present principles, the web matching engine 10 is used by information providers or third parties for custom notifications and the creation of a dashboard like facilitator which will collect alarms and notification information from the Internet and third parties. Here, subscribers are permitted to bid to be ranked highest to affect the order by which notifications may be sent out, as well as the time delay the subscriber may request before the message may be sent out to other competing subscribers.

In accordance with an aspect of the present principles, advertisers (i.e. buyers) may embed complex tags, links, triggers and other forms of code to track the interaction of users with their offers sent by the matching engine so they can match ads to actual orders on their systems and measure in high degree of assurance their conversion rates and cost per new order or new customer. By linking such results from their supply chain and internal systems directly to the web matching engine 10, advertisers can automatically direct their budget away from groups and users who have low conversion rate to leads, notifications, events and triggers which have high conversion rates and reliably count on such data.

The contemplated embodiments represent only a small fraction of the uses web matching engine 10 may provide to businesses and individuals who need to be notified about events and changes occurring worldwide. For example, in other embodiments, the web matching engine 10 may also function as a third party web service clearinghouse to many other search engines and websites seeking to outsource the notification and management of their subscribers. As a result, an efficient and managed notification system is achieved, which simplifies and provides for a manageable individual portal of notifications and information. Such a solution may be integrated with existing email or IM programs to provide integrated messaging. Here, web matching engine 10 can be used to provide free instant messaging for wireless devices by placing relevant ads or key word banners based in content sent from one wireless subscriber to another. As a result, the system of the present principles replaces an SMS system, where the sender and receiver pay for each message that is sent over the system. Similarly, an instant messenger or any other program can link via web services or xhtml to web matching engine 10 and use it to serve ads or content to the buyers 100 or subscribers.

In another embodiment, web matching engine 10 may charge some publishers for their data, while paying other publishers for their data. For example, a company issuing a press release may have to pay for submitting its data to the matching engine, while a newspaper writing about such press releases may be paid by the web matching engine for the submission of its data. In a similar way, a subscriber to the web matching engine may pay to receive notifications from specific information sources, while being paid each time the notification from others is read. Here, the function of information exchange 10 is to collect, process, notify and settle the financial transactions resulting from each transaction triggered by the matching engine based on a pre agreed financial formula entered by its members.

The matching performed by web matching engine 10 can be based on multiple algorithms all of which are trying to generate better and better matches and ECPM or Effective Conversions Per M hits. The matching engine seeks to find the best way to pay publishers the highest rate per click or banner while providing advertising a match to the site and specific page which will provide the best ECPM compared to all other options available on the web.

One algorithm of the web matching engine ranks all advertisers into categories based on product or service they provide and then matches such categories with the historical average ECPM for such category from the history of transactions conducted on the system. Such score is then used to dynamically manage placement of ads for any advertiser in that category to ensure they get above average ECPM linked to the profile they placed with the system.

Such management is segmenting all of the web and other media available spots into a select group which can achieve certain ecpm for such category. As the volume of transactions increases so does the effectiveness of such matching. Advertisers can lower their ECPM score if they need broader exposure or can't find sufficient sites to spend their budgets. On the Publisher (i.e. seller) side the publishers can see the ECPM results for each product category and modify their sites and their content to improve their ECPM ranking within the group or add or switch to other product categories where they can get better monetization for their inventory. Since all such information is transparently available to both sides they can continuously adjust and improve this model to perfection.

The system can charge for access to such information as part of its revenue sources. Publishers are ranked by the system based on their ECPM in all categories resulting from historical transaction data. The system may recommend to them the highest prices they can charge and show them where they would land against all other publishers in each such category. The system allows advertisers to see each individual publisher site or banner or the entire listing and ranking in each category without any anonymity but they can also just place automated orders to spend the budgets and let the system select which publishers will be selected. On the other hand Publishers can see the budgets and ECPM results of each category but not the Advertisers and their identity.

FIG. 2b shows a plan view of the web matching engine 10 according to an embodiment of the present principles. In particular, FIG. 2b shows the two (2) operating layers of the web matching engine 10. There is the ad trading layer 50 that is made up of a business management layer 31 and a service management layer 32, and the service delivery layer 52. The buyers 100 and sellers 120 and their respective ad servers 148 and 126, are members or subscribers to the web matching engine. The buyers 100 and sellers 120 are connected to the ad trading layer 50 via the web trading interface 33 and the service delivery layer 52. The web interface 33 is preferably a website or web based application that allows the buyers and sellers to enter their orders, and to view the status of campaigns and all relevant financial and performance information relating to the same. Each of the layers 50 and 52 are connected to the data warehouse 34 which collects information relating to each and every transaction conducted by the buyers and sellers. The business management layer 30 of the ad trading layer 50 can include order management, matching of orders to prospective buyers, billing, settlement and reconciliation, rating and risk management, reporting and financial accounting. The service management layer 31 performs data collection, match plan generation, issues orders to move media and/or digital goods, track and report transactions, usage mediation, quality control and trouble ticket handling. The service delivery layer 52 includes ad Media and ad servers, the digital goods being offered, certificate and authentication management, security and capacity management, and delivery and reporting to the respective networks and users of the market place.

FIGS. 2c and 2d are exemplary schematic block diagrams illustrating the processing of information collected by the web matching engine 10 of FIG. 1 according to one embodiment of the present principles where newly added information is processed and provided to the users of the system.

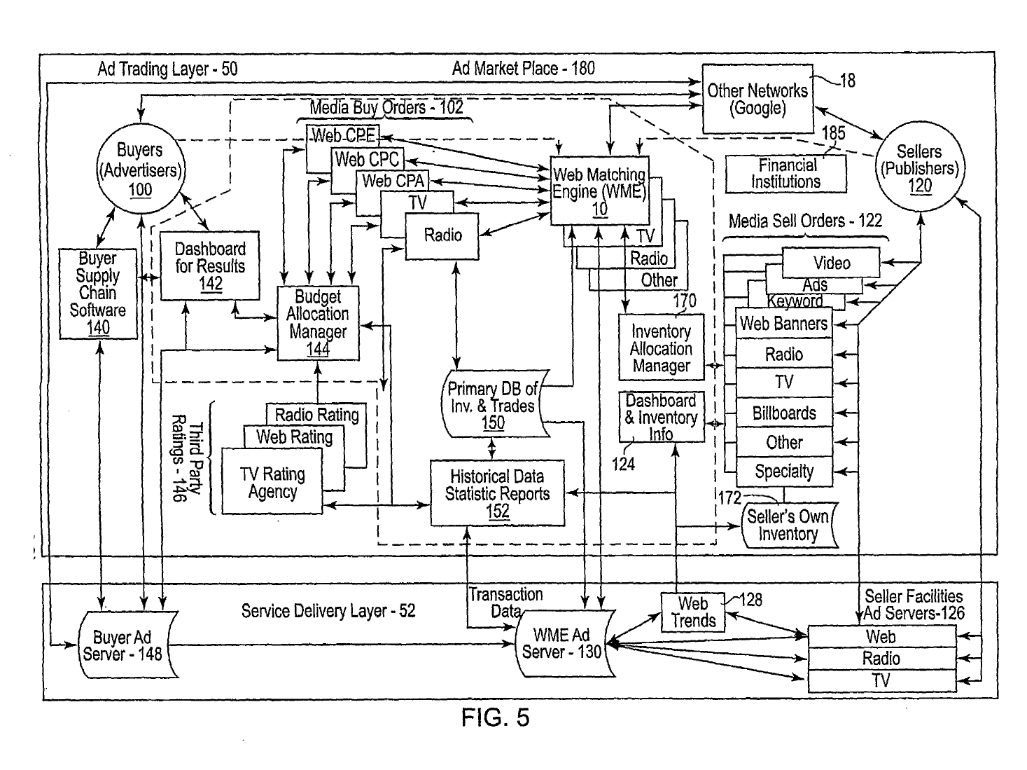

With specific reference to FIGS. 2c and 2d, content from the information sources and publishers 1017a, 1017b, 1017c is collected and provided to a message logic flow module 1021. The message logic flow module 1021 determines the source, content, priority, size, relevance and uniqueness of the information. In alternative embodiments of the present principles, other attributes such as historical information, related information, a ranking of the importance of the information, uniqueness of information, etc., are added to the message logic flow (See example of FIG. 5 and corresponding description). This is possible because all message information is derived from the XML and other protocol information that are provided with website links.

Web matching engine database 1022 or a memory resident hash table is used to store queries and counter and statistical analysis data in the index and counter module 1015. The data in the information flow may be compared to other information located in web matching engine database 1022 (e.g., information stored within index and counter module 1015, and forwarded to other parts of the web matching engine 10 or discarded.

Information exchangers or other aggregators, such as information brokers 1020, are permitted to exchange additional information with the web matching engine 10. A controller 1024 is preferably integrated with the web matching engine 10. The aggregators 1020 are managed by the controller 1024 which verifies and handles communication and content delivery to the users 1012. The controller 1024 may allow certain information to flow directly from message flow logic 1021 to message engine 1025 if it is determined that the information is for public interest such as a notice from the federal government or a critical news alert. The controller 1024 is also used to validate users 1012 and to administer user preferences and rights to access and pay for certain information.

After the content in the information is processed by the message flow module 1021 in the web matching engine 10, a specific set of searches is conducted by the text search and parse engine 1025 against text index and database search entries located in the index and counter module 1015 to located matches and related links. The matched results are provided to a prioritization engine 1026 which uses user queries stored in query directory 1023 of web matching engine database 1022 to rank the search results based on rankings stored in ranking directory 1028 of web matching engine database 1022. The prioritization engine 1026 also forwards the ranked results to the administration module 1027 of the web matching engine, and accesses a billing and settlement database 1030 which stores billing, settlement, notification and reporting information to confirm the identity of subscribers who need to be notified of their status and credit standing. Database 1030 also performs all billing functions such as charging, collecting and crediting the appropriate parties against their transactions. The same member of the matching engine may be charged in one transaction and be paid in the next, resulting in netting of all their charges and credits by the web matching engine.

The prioritization engine 1026 forwards the search results to message engine 1025 which packages the search results with specific ads stored in ad registry 1029 of the web matching engine database 1022 or other external ads and results and forwards them in the format and at the schedule requested by the subscribers to a predetermined destination, such as an internal web-log, external email, web agents 1032, communication devices 1031 and/or servers 1033. The messaging engine 1025 updates the billing and settlement database, to ascertain who should be charged for what and who should be credited as a result of the notice just sent since each notice may have a different combination and content and as such different pricing to the parties involved. The web matching engine thus allows real time pricing for each transaction in contrast to today's static advertising environment.

After a subscriber is provided with a notification that requested content is available, a billing record is generated by a combination of the various processing modules of the matching engine and sent to the billing and settlement database 1030 so that real time settlement and billing information can be generated for internal use, as well as for use by external users of the web matching engine 10. It should be noted that some of the aforementioned steps may be skipped if, for example, the subscriber is a search engine which is using the web matching engine 10 to collect all published data, but is not billed for the receiving the information or any advertisements from the matching engine.

In accordance with the present principles, a subscriber may enter a website 11 via a computing device 1031, servers 1033 or web agents 1032. Preferably, the computing device is a PDA, computer, mobile phone or some other web enabled device.

The entered search data is distributed by the web matching engine 10 to the multiple modules or databases in matching engine database 1022 and compared to historical results, such as traffic volumes. In accordance with the present principles, the subscriber may be provided with instant feedback on the frequency of the entered search data and the likely sources to provide such information in the future. The subscriber may then modify the request or confirm his entry. Upon confirming the entry, the multiple modules or databases in matching engine database 1022, in combination with the available data in the billing and settlement database 1030, will determine if such a query is at no fee or should be charged, and will notify the subscriber of the decision. If the transaction is accepted by both parties, all relevant depositories in matching engine database 1022 are updated, and an attempt to match all new information from the information providers 1018 that is loaded into information sources and publishers 1017a, 1017b, 1017c and the aggregators and brokers 1020 is performed. If a match occurs, relevant ads and other information are packaged and distributed to the relevant subscriber(s).

An advertiser 1034 may enter a website 11 and identify key words, trigger events, profiles of users or a minimum number of user groups in which he is interested. Here, a subscriber may view historical traffic volumes and prices paid by other advertisers for the identified categories or he may place complex instructions with the administrator module 1027 to initiate ads or notifications under certain specific conditions or be added to certain user or interest groups which may pay a high price for accepting notifications. Such entries are processed by the web matching engine 10, matching engine database 1022 and billing and settlement database 1030. The entries are continuously monitored in order to optimize matching and spending by advertisers 1034 on the web matching engine 10. Such system provides for market based balance of supply and demand between advertisers and users or buyers which is governed by conversion rates instead of artificial pricing of keywords, the latter of which has no correlation to results or to the price of such hits.

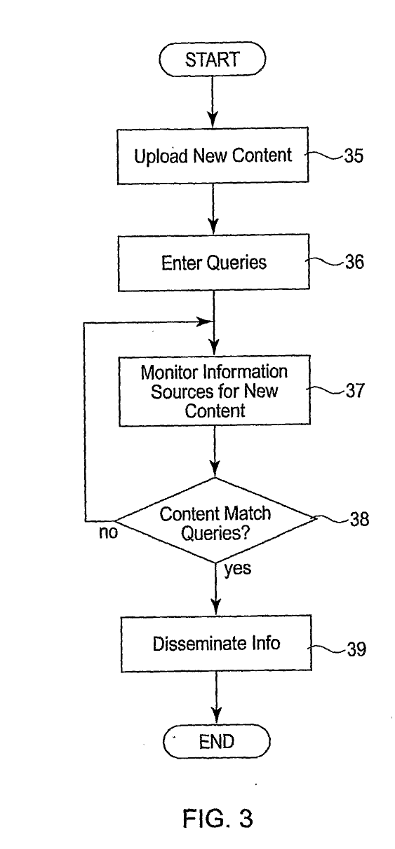

FIG. 3 is a flow chart illustrating the steps of the method of the present principles in accordance with the present principles. The method is implemented when new data is uploaded to the web matching engine, as indicated in step 35. Here, the new data is content that is uploaded to the web matching engine 10 by information providers or administrators 1018. The new data is made available to publishers 1017a, new networks 1017b and/or web servers 1017c or other information sources (IP).

Search queries are entered and stored in the system database by users 1012 or subscribers to the system, as indicated in step 36. In this case, the web matching engine 10 receives requests via other programs, brokers or aggregators or search engines 1014 in “wholesale” data feeds. The requests may be generated by an operating system or a specific application while a user operates a wireless device or a computer or each time a search is performed using a browser or the Internet. The users 1012 may be asked if they wish to be notified about new results on such a search in the future. If the invitation is accepted, the query is combined with other information provided by his device or computer, web service, or the search engine used, such as advertisements stored in ad database 1016. Here, advertisers use the website 1011 and system database 1013 to place bids and contract with web matching engine 10 and its partners to deliver specific ads and information to a target audience.

The combined information is translated into a complex query based on the user's profile, other previously entered user information and/or a ranking of search results. This new query is entered into the system database 1013 as a predetermined “static” query, which is accessed by web matching engine 10.

The web matching engine 10 continuously monitors the uploaded data to determine whether new data has been added to the web matching engine by the information providers or administrators 1018, as indicated in step 37. Next, the web matching engine 10 compares every piece of new data that is collected to a list of static queries entered by the users 1012 or subscribers to locate content in the new data that matches the queries entered by the users 1012, as indicated in step 38. If no match is obtained, a return to step 37 occurs, where the web matching engine resumes monitoring the uploaded data to determine whether new data has been added to the web matching engine 10.

If a match is obtained, it is analyzed via a logic flow, text searched and prioritized before a message engine translates it into a web link or combines it with other statistical or relevant data stored in the index and control module 1015 (see FIG. 2).

At this stage, the web matching engine 10 may attach advertising or promotional information provided by third parties based on the subscriber's query or the topic sent to a profile of the subscribers. In addition, the web matching engine 10 may charge a fee to the subscribers and third parties for distributing information based on an agreed amount, a transaction fee or a dynamic market in which advertisers bid for the right to be included first in such notifications.

The matching content is then sent to the subscriber or agent (e.g. broker, etc.) who ordered the query over the web matching engine 10, as indicated in step 39. The information is disseminated to the user or subscriber in a specific format and to a specific device, such as a computer, cell phone, PDA or some other web enabled device.

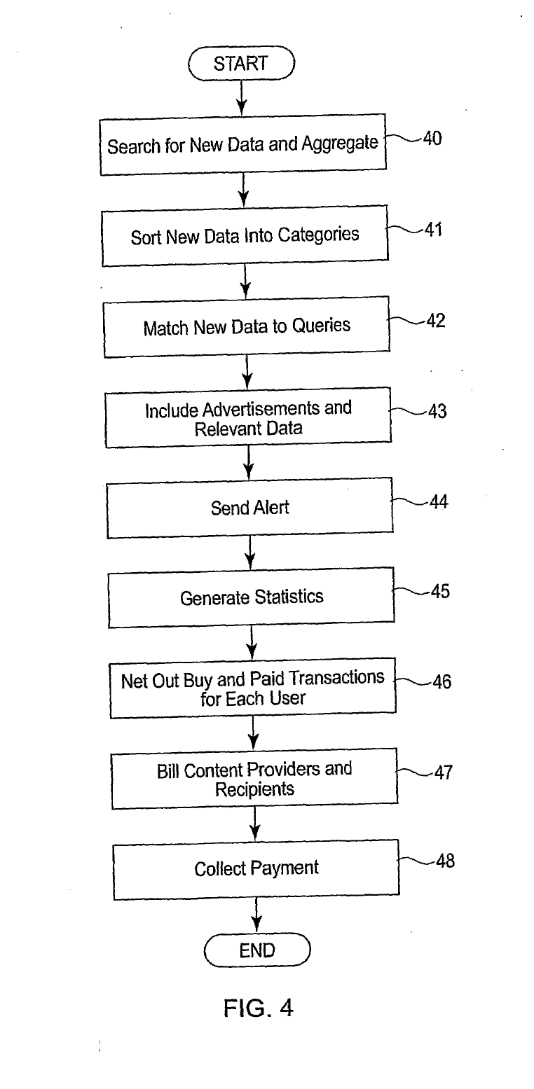

FIG. 4 is a flow chart illustrating alternative steps of the method in accordance with the present principles. The method is implemented when a search for new data is performed, as indicated in step 40. Once the new data is located it is aggregated and processed for temporary storage or indexing and stored permanently so such information can be matched to each search and profile query entries made by subscribers of the web matching engine.

The aggregated data is then sorted into new categories, as indicated in step 41. Next, advertisements and relevant data are included in the new categories, as indicated in step 42. Here, the ads are ads that were previously placed in the system by advertisers who used the website 1011 and system database 1013 to place bids and contract with web matching engine 10 and its partners to deliver specific ads and information to a target audience.

Alerts are sent to users or subscribers based on the queries that were previously entered, as indicated in step 43. Here, the combined information is translated into a complex query based on a user's profile, other previously entered user information and/or a ranking of search results as well as third party trigger events such as news, key words and change in prices or total users in a specific group.

Statistics related to the delivery and accessing of the ads are generated, as indicated in step 45. A calculation of purchases and payouts by each user is performed, as indicated in step 46. Here, the matching engine 10 calculates the amount advertisers and third parties need to pay and the amount due to any publishers or users based on pre agreed terms published on the matching engine, and then credits each user account.

Each content provider and user is then billed, as indicated in step 47. The collection of payments is then performed, as indicated in step 48. Here, billing and settlement database 30 is used to performs all billing functions, such as charging, collecting and crediting the appropriate parties against their transactions.

FIG. 5 is a schematic block diagram of the system in accordance with a preferred embodiment of the present principles. The embodiments shown in FIGS. 5-10 represent not only newly added information to the networks by sellers, but also includes comparisons with existing static information that may have been added days, week or even months ago. In this manner a completely automated system can be provided that reduces latency in ad placement and provides a more streamlined buyer and seller interaction. By way of example, FIG. 5 shows an ad trading layer 50 and a delivery layer 52. The ad trading layer 50 includes the ad market place 180 established by the web matching engine of the present principles. The ad market place 180 is made up of the web matching engine 10, a primary database of trades and inventory 150, historical data 152, the media buy orders 102 of the buyers 100, a budget allocation manger 144, third party ratings 146, a seller inventory allocation manager 170, and a dashboard or GUI for each the seller 124 and the buyer 142.

In an automated embodiment, buyers 100 place orders on the web matching engine 10 which are delivered via the delivery layer 52, while the sellers 120 place orders to the web matching engine through their media sell orders 122 and inventory allocation manager 170. When operating in this automatic mode, the system is capable of calculating the highest prices possible that can be charged based on the buyers budget allocation. In this manner, the dynamic change of pricing can occur and actually function to increase prices when it is determined that more money can be made, and the sellers are under pricing the media space. In a non-automated operation mode, both the buyers 100 and sellers 120 are connected directly to the web matching engine 10 and can deal directly with each other without the automated aspects of the present principles. When operating in a non-automated mode, the buyers 100 and sellers 120 will be seen directly by each. For example, the buyers will see the transactions on the supply chain 140 and the sellers will see the transaction on their dashboard/inventory manager 124.

The sellers have a dashboard (or graphical user interface—GUI) 124 that they use to view the collection of all their trading and external data which shows them monetization and performance of their inventory compared to historical data on the market place 180 which represents the benchmark for such inventor. The Sellers 120 can view their inventory of media space, pricing, etc. The sell orders 122 can come in many different forms. Some examples, such as, Video, Ads, Key Word, Web Banners, Radio, TV, Billboards, Special interest, and other sites or placements. Other types of sell orders 122 may also exist without departing from the spirit of the present principles.

The buyers 100 use supply chain software 140 that allows the buyers to collect conversion information from their inventory, web sales, call center and other sources and use such data to better pick and choose various media that they are interested in placing an advertisement. The buyers 100 also have a dashboard (GUI) 142 that enables them to view results of their purchases from the market place 180 and other sources and sales activity relating to the same, in real time. A budget allocation manager 144 allows the buyers to manage their advertising budgets for each of the respective buy orders 102 that the buyer is interested in placing and compare them to other options outside the market place as well as all available historical data from database 152 so the best buy decisions can be made. The buy orders can be in any form for any media space, such as, banner ads, keywords, video segments, product placements, exposure or cost per click (CPC), cost per acquisition or conversion (CPA), TV and radio. The budget allocation manager 144 receives information from a plurality of third party rating systems 146, which includes, for example, radio ratings, web ratings, TV ratings, etc, and also a historical data/statistic reporting service 152. The historical data/statistical reporting service 152 is directly connected to the primary database 150 of the ad trading layer, to provide it with rating and statistical information to perform such matches, the rating agencies and the budget allocation manager 144. The historical data/statistical reporting service 152 is also connected to the ad server 130 of the delivery layer 52 to initiate transactions from the same. The delivery layer 52 awaits instructions from the buyers 100, market place 180 and sellers to initiate and deliver ads or other digital goods upon the completion of transaction between buyers and sellers via the ad market place 180 or outside of it.

In an automated embodiment, the buyers 100 have the option to work with the budget allocation manager 144, however, should the buyer wish to work manually without the system, the buyers 100 are also directly connected to the web matching engine 10 and other networks as well as directly to the sellers so as to enable operation in an un-automated or manual way. Buyers and sellers may continue to use parts of the system to optimize such relationships while using the market place 180 for other transactions. In such an arrangement, the market place 180 collects information on all such external transactions and uses it to continuously optimize it to increase monetization and conversions for sellers and buyers.

At the delivery layer 52, the sellers 120 have a plurality of seller facilities ad servers 126, such as, for example, web, radio, TV, etc, that can be used by the buyers or the ad database 130 to store and deliver ads or digital goods. The information transmitted by the sellers facilities (ad servers) 126 can include transactional information that is passed on to the historical data/statistic reporting unit 152. The transactional information can be related to the web, TV, Radio or any other media space the sellers is associated with. The transaction is collected by programs such as, for example, web trends 128 which may share that data to assist the buyers and sellers in making comparisons and decisions relating to their buy orders. Such data is aggregated from many sellers and buyers and just the averages and trends are shown to the buyers so they can make better decisions, and on the other hand, buyers may elect to show sellers specific detailed transactional information from their supply chain or other systems, or just elect to share data into the historical data 152. The ad server 130 is a storage facility where ads can be stored so as to minimize any further latency in the delivery of purchased advertising space.

In accordance with the present principles, the web matching engine 10 is operated so as to aggregate, sort, rank, attach relevant info, publish, bill, collect and pay the appropriate parties it may be linked to financial institutions 185 to effect such payments and transfers between members of the market place 180. By using Really Simple Syndication (RSS), web services, other protocol based information feeds from different web based and proprietary network sources. The WME 10 collects buy and sell orders from millions of buyers and sellers and segments them by variety of categories and profiles. It also collects historical data and other information from inventory 170, budget allocators 144 and other external sources and correlates such data to create matches between buy and sell orders. Such matches are translated into route plans which are loaded on the appropriate ad servers so they can deliver the right ads to the right places at the right time. The WME 10 continuously collects transaction information from ad servers 130, 148, and 126, ratings 146, web trends 128, primary database 150, other networks 18, and from users to augment and optimize the route plans on the ad servers as changes occur inside the Ad Market Place 180, and outside data is collected and redistributed to budget allocation manager 144 and dashboard 142 for buyers and inventory manager 170 and dashboard Inventory 124. Such data is processed and recommendations for adjustments in buy and sell orders are generated by the system to better the fulfillment to buyers and provide better monetization for sellers. Both buyers and/or sellers can decide to accept such recommendations manually or automatically implement them. Sellers may publish their matching information which is accumulating in ad servers 126 and 130 and web trends 128 to improve their rankings by the WME 10 and provide better monetization. Buyers may publish conversion information from supply chain 140, dashboard 142 and other sources to allow WME 10 and other sellers to match better to such buyers needs. The information in WME 10 is always going to be more accurate and current than any news gathering organization or search engine using crawlers or outbound information gathering tools. In addition, real-time notification and access to the information is provided. In accordance with the invention, recently published news, inventory information, new prices and services or products are published into the system. Upon entry of the information, it is processed and distributed by the system to people, related parties or other systems that have expressed an interest in being notified of the type of published information as it becomes available. RSS is an XML format for sharing headlines and other web content.

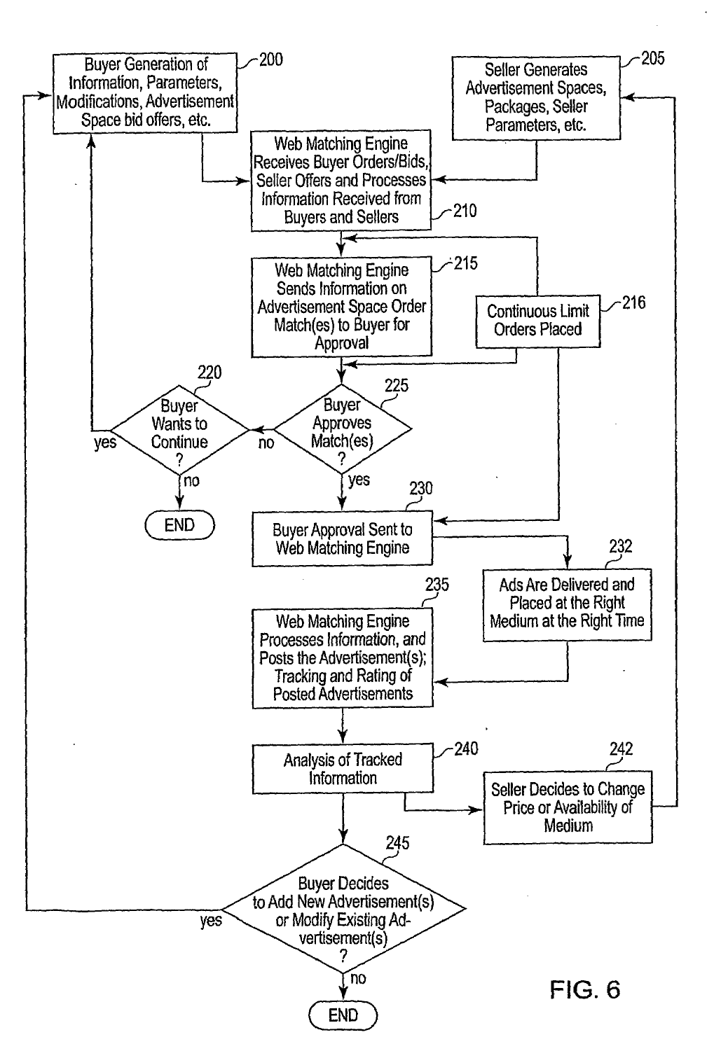

FIG. 6 is a flow chart illustrating the steps of the method in accordance with an embodiment of the invention. The buyer of an advertisement space generates all preliminary information about the desired advertisement space, step 200. Here, the buyer may set parameters, such as the dollar amount to be spent daily, the mediums to be used, the minimum conversion numbers, the scope of the geographic coverage, the user's profile and historical data and the maximum prices to be paid for specific keywords. The buyer also designates the parameters for placement of the advertisement, such as when, how and based on what events to increase or decrease buying. In addition, the buyer modification of existing advertisement placements, following tracking information on the placements' success is also performed, where the buyer may view a dashboard (e.g., a graphical user interface—GUI) and supply chain information as well as pricing to make changes to buy orders. Further, the buyer may also view advertisement space offers for other mediums placed on the web matching engine and compare the effectiveness of the proposed advertisement medium. Here, the buyer may place bids on the advertisement space offers.

Concurrently with the buyer generation of the preliminary information, the advertisement space seller generates advertisement space and prepares advertisement packages that may be purchased by buyers for single or multiple mediums he controls, step 205. In accordance with one embodiment, the generation of the ad space and packages is performed using at least one of data from a dashboard database, seller inventory and a competitor's pricing that is based on information obtained from the web matching engine or the buyer's prior behavior patterns. The seller can add or adjust his available inventory prices and availability up or down based on the balance of supply and demand in that specific segment of the advertising space for that specific time period.

Next, the information from both buyers and sellers is sent to the web matching engine, step 210. Upon receiving all of the information from both the buyers and the sellers, the web matching engine performs a search to locate matches between buyer orders and seller offers. In certain embodiments, the buyer's orders include bids. In addition, the web matching engine processes information received from buyers and sellers regarding the parameters for buyer orders and seller offers. Buyers and sellers are permitted to view each other's actual listed prices, the actual prices listed by the system, as well as third party conversion information related to each buyer. As a result, the buyers and sellers are permitted to match their inventory to buyers and sellers that will best utilize the ability to view the actual listed prices of the other buyers and sellers, as well as the actual prices listed by the system. In certain embodiments, sellers may list their names and their inventory so that buyers can sample the available inventory. Alternatively, buyers may also list their names associated with just their industry.

Next, the web matching engine sends information on any suitable matches to the buyer for approval, as indicated in step 215. The buyer then decides whether to approve the sent match, as indicated in step 225. If the buyer does not approve of at least one match that is presented by the web matching engine, the buyer determines whether to continue with the process, as indicated in step 220. Here, buyers may place continuous limit orders with the web matching engine. Such orders are instructions for the web matching engine to maintain and place ads in different locations with sellers whose performance exceeds the minimum requirement set by the buyer. For example, a buyer may place an order to buy $100,000 of US web advertising with a maximum $4 cost-per-click (CPC), a $1 cost-per-thousand (CPM) and a $25 (CPA) for jewelry listings. The web matching engine then monitors all cost-per-click ads available and their pricing information and attempts to match such ads within the budget provided by the buyer until the buyer's budget is spent. In accordance with one preferred embodiment of the present principles, the web matching engine the can use the Basian theory of prediction of ad value and then perform ad placement based on the same.

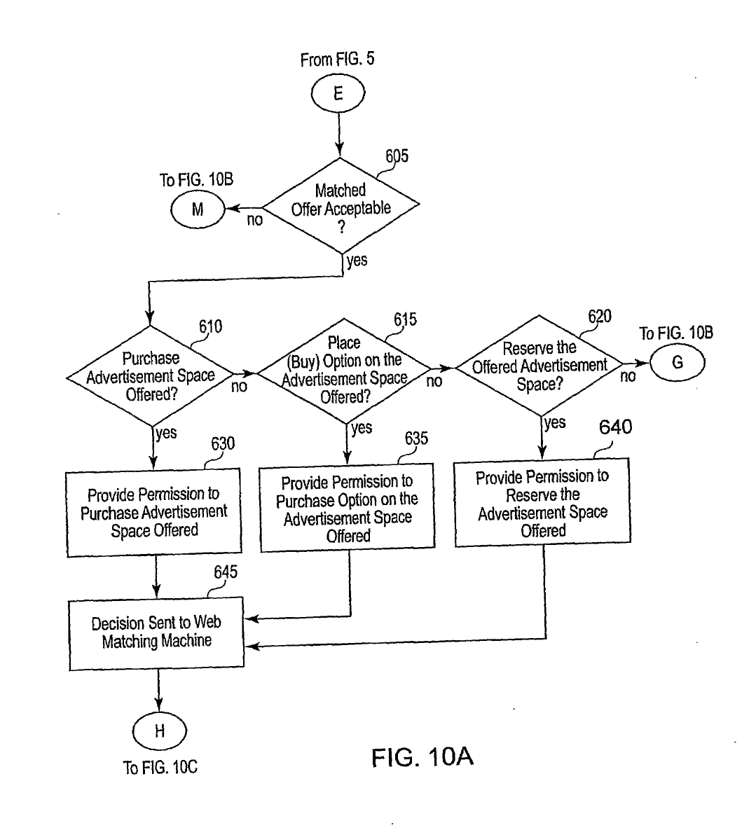

On the other hand, if the buyer approves at least one match that is presented by the web matching engine, then the buyer sends his approval to the same, step 230. Next, the web matching engine processes the buyer's approval and instructs the ad content database (see FIG. 9) to post the advertisements on the selected media at the selected times, steps 232 and 235. At this point, the ad content database collects transaction information from the applicable web or media servers, and other third party tracking agencies. The ad content database then tracks and rates the performance of the posted advertisements and reports such information to a matching engine of the web matching engine, pricing database and to other parts of the system. As a result, other buyers and transactions can be changed if necessary, based on the results generated by the applicable medium.

Next, the information obtained from the tracking agencies are analyzed, at step 240. Here, the web matching engine may determine that a particular advertising medium is more effective for diamond sales and not shoes and thus, perform a real-time exchange of ads placed on a specific advertising medium. In accordance with an embodiment of the present principles, the web matching engine then sends the resultant tracking information to the buyer primarily performs the analysis. Upon receiving resultant tracking information, the buyer decides whether to add new advertisements or modify the existing advertisements, at step 245. If the buyer decides not to add or modify the existing advertisements, the method is terminated. However, if the buyer decides to add a new advertisement or to modify an existing advertisement, then a return to step 200 occurs, where the buyer is permitted to generate new information, provide new parameters for a new advertisement or perform modifications to an existing advertisement.

Also at this point, the seller can decide to change the pricing or availability of any particular medium, step 242. At which point, the process reverts back to step 205 where the seller generates the available spaces, packages, etc to the web matching engine.

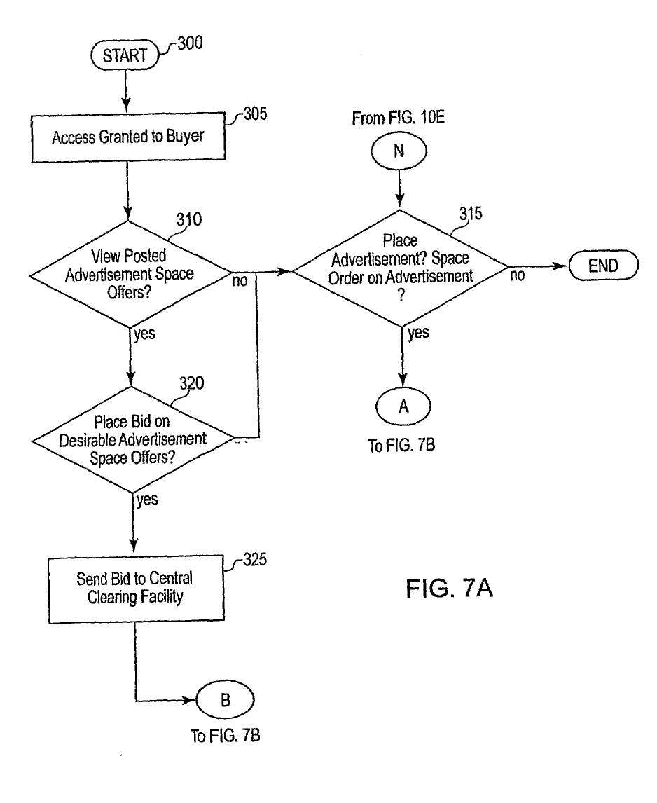

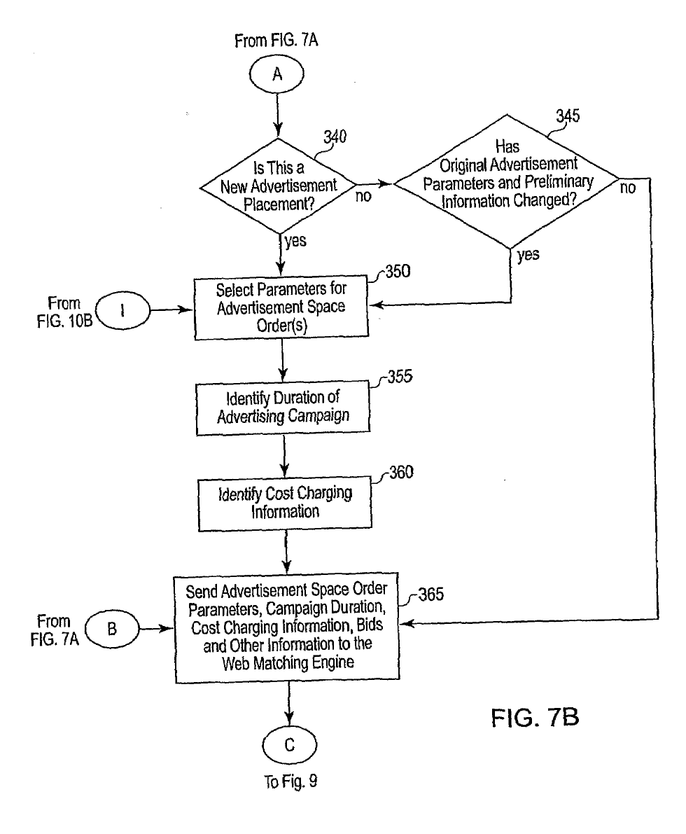

FIGS. 7(a) and 7(b) are flow charts illustrating the steps associated with the activities of a buyer up to the transmittal of advertisements from the buyer to the web matching engine 10 of FIG. 1. The buyer is granted access to the central clearing facility, step 305. The buyer then determines whether he wishes to view posted advertisement space offers, step 310. If the buyer wishes to view the advertisement space offers, the buyer then determines whether to place a bid on any offer deemed desirable, step 320. If the buyer chooses to place a bid, the send a bid or bids on the advertisement space offers to the central clearing facility for subsequent use in accordance with the method of the present principles, at step 325.

If, on the other hand, the buyer does not want to view or bid on previously posted advertisement space offers, they determine whether to place an order for advertisement space, step 315. If the buyer does not want to place an order, then the method is terminated. If, however, the buyer does want to place an order, they determine whether the advertisement placement is new, step 340. If the advertisement placement is new, the buyer is presented with the option to select parameters for the advertisement space orders, step 350. If, on the other hand, the advertisement placement is not new, then the buyer determines whether the parameters of the existing advertisement and preliminary information have changed, step 345. If a change in the parameters of the existing advertisement and preliminary information has occurred, then the method returns to step 350, where the buyer is presented with the option to select parameters for the advertisement space orders. If, however, a change in the existing advertisement and preliminary information has not occurred, then the buyer is presented with the option to re-send the advertisement space, parameters, campaign duration, cost changing information and other preliminary information to the web matching engine, at step 365.

After selecting parameters for the advertisement space orders in step 350, the buyer identifies the duration of the advertising campaign, step 355. Next, the buyer identifies the cost charging information, step 360. Information is then sent to the web matching engine, along with other advertisement space, parameters, campaign duration and cost charging information for subsequent use, step 365.

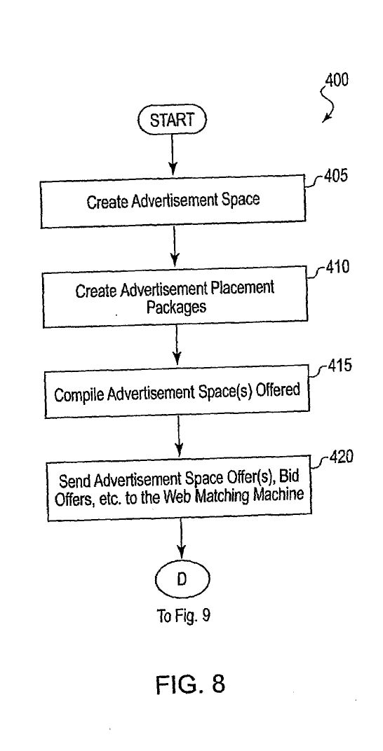

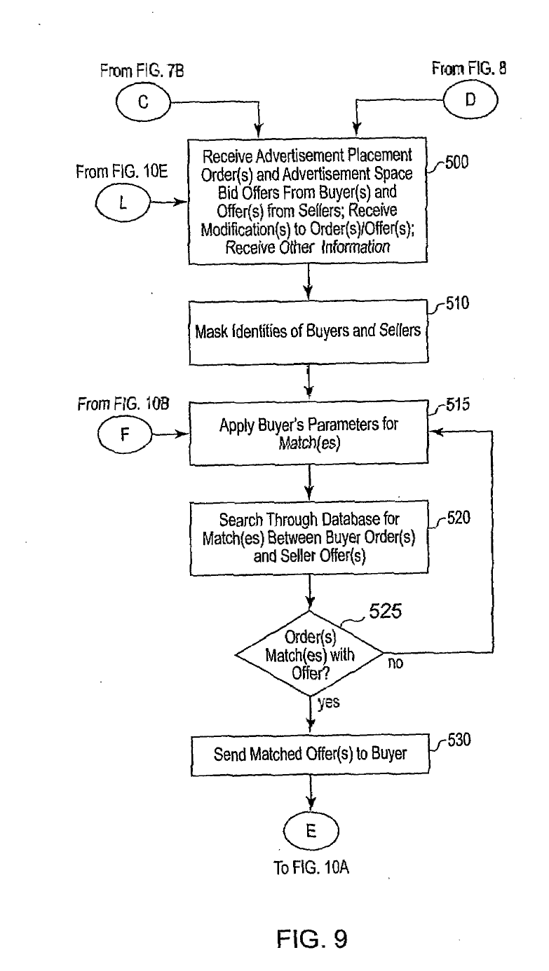

FIG. 8 is a flow chart 400 illustrating the steps associated with the activities of a seller up to the transmittal of the advertisement space or package offers from the seller to the web matching engine 10. Here, the seller creates advertisement space, step 405, and creates advertisement placement packages that the seller will offer to buyers, as indicated in step 410. Next, the offered advertisement space is then compiled, step 415, and then sent to the web matching engine for subsequent use, step 420.

FIG. 9 is a flow chart illustrating the steps associated with receiving, processing and matching buyer orders and seller offers at the web matching engine 10 of the present principles. Initially, the web matching engine receives the advertisement placement orders from the buyers and advertisement placement offers from the sellers, step 500. At this point, the web matching engine also receives modifications to existing orders or offers and receives other information from both buyers and sellers.

Next, the web matching engine masks the identities of all participant buyers and sellers, step 510. The matching engine then applies the buyer's parameters for matches with seller offers, step 515. Pursuant to applying the buyer's parameters, the web matching engine searches through the database for matches between buyer orders and seller offers, step 520. Next, the web matching engine determines whether an order matches with an offer, step 525. If a matching order is not located, then a return to step 515 occurs, where the web matching engine once again applies the buyer's parameters to locate a match. If a match is located, then the web matching engine sends the matching offers to the particular buyer for use in accordance with the method of the invention, at step 530.

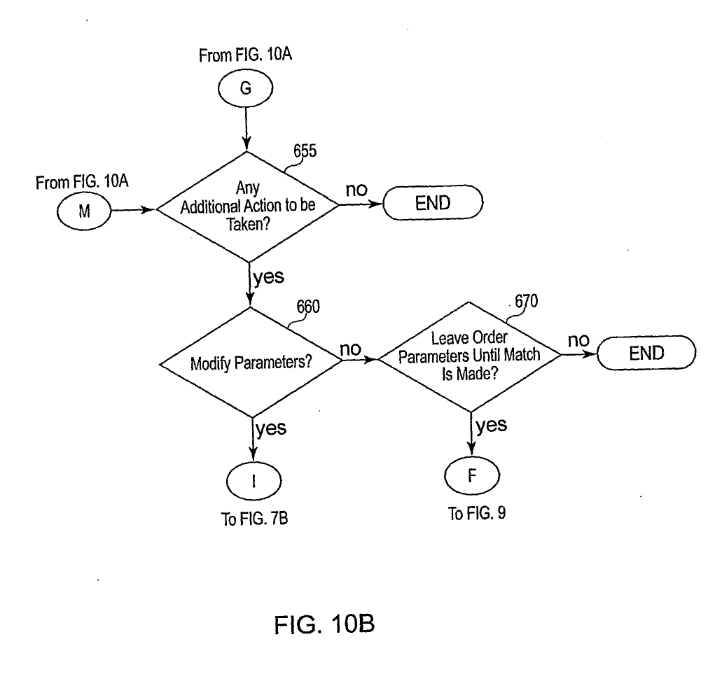

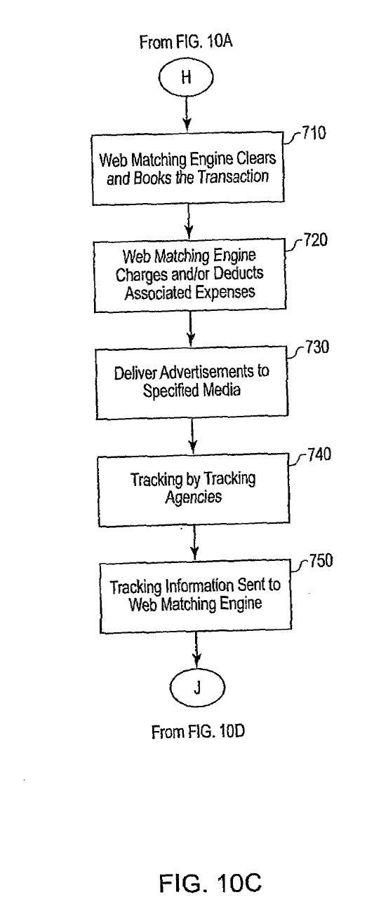

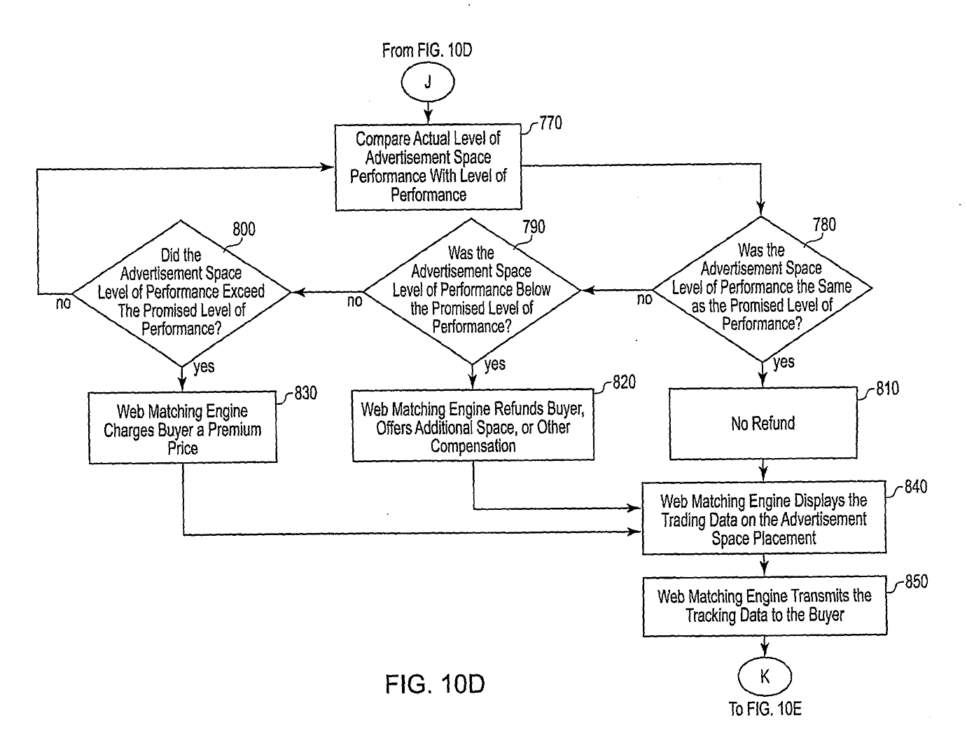

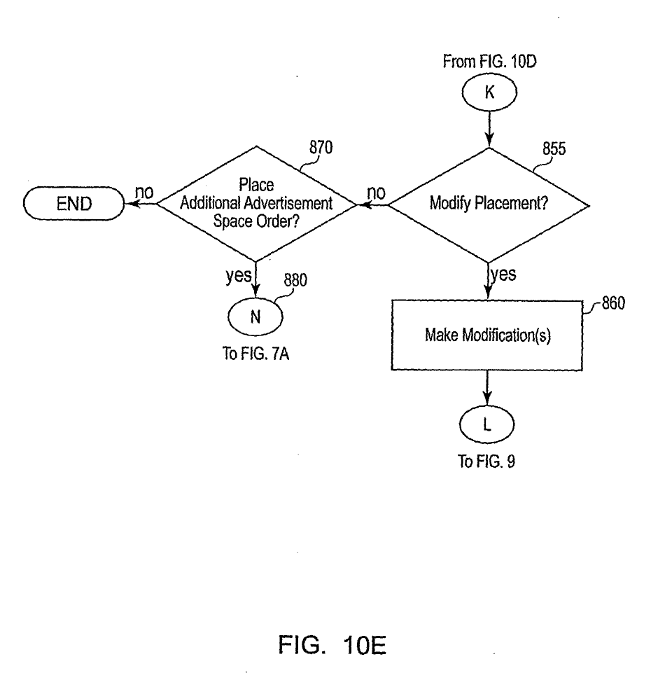

FIGS. 10(a) thru 10(e) is a flow chart illustrating the steps associated with the decision-making that is performed by the buyer after the web matching engine has located at least one match between the order from the buyer and at least one offer from the seller. The buyer views the order to determine whether the matching offer is acceptable, at step 605. As illustrated in FIG. 10(b), when an offer is unacceptable, the buyer determines whether any additional actions should be taken, at step 655. If an additional action is not required, the method is terminated. However, if additional action is required, then the buyer determines whether to modify the existing parameters of an existing advertisement, at step 660. If the buyer elects to make modifications in the parameters of the existing advertisement space, a return to step 350 of FIG. 7(b) occurs. However, if the buyer does not elect to modify the parameters of the existing advertisement space, the buyer then determines whether to leave the existing order parameters until a match is made, at step 670. If the buyer elects not to leave the order parameters until a match is made, the method is terminated. On the other hand, if the buyer elects to leave the order parameters until a match is made, a return to step 515 of FIG. 9 occurs.

Returning to FIG. 10(a), if the buyer determines that the match is acceptable at step 605, they then determine whether to purchase the offered advertisement space, at step 610. However, if the buyer elects not to purchase the advertisement space, then the buyer determines whether to place an option on the offered advertisement space, as indicated in step 615. Here, as before, if the buyer elects not to place an option on the offered advertisement space, the buyer then determines whether to reserve the offered advertisement space, at step 620. If the buyer determines that he does not want to reserve or place an option on the advertisement space or purchase the offered advertisement space, then a return to step 655 of FIG. 10(b) occurs. However, in the case where the buyer elects to either purchase the offered advertisement space or place an option on the offered advertisement space or reserve the offered advertisement space, the method proceeds to one of steps 630, 635 and 640, respectively. Here, the buyer is provided with permission to either purchase a placement option or reserve the advertisement space that is offered for purchase. The decision of the buyer is then sent to the web matching engine, step 645.

Referring to FIG. 10(c), the web matching engine then clears and books the transaction, as indicated in step 710. The matching engine then charges and deducts, where applicable, associated expenses associated with booking the transaction, step 720. Next, the web matching engine delivers advertisements to specified media, step 730, obtains tracking information by tracking agencies to monitor the performance of the posted advertisements, step 740, and then sends the tracking information to the matching engine for analysis, at step 750.

Referring to FIG. 10(d), the web matching engine then compares the actual level of advertisement space performance with a promised level of performance, at step 770. It then determines whether the advertisement space performance matches the promised level of performance, step 780. If the advertisement space performance matches the promised level of performance, then the web matching engine does not pay a refund to the buyer, step 810. However, if the advertisement space performance is not the same as the promised level of performance, then the web matching engine determines whether the advertisement space level of performance was below the promised level of performance, step 790. If the advertisement space level of performance was below the promised level of performance, then the web matching engine pays a refund, issues a credit or offers additional space of other compensation to the buyer, at step 820. If the level of performance was not below the promised level of performance, the web matching engine determines whether the advertisement space level of performance exceeded the promised level of performance, at step 800. If the advertisement space level of performance exceeded the promised level of performance, then the web matching engine charges the buyer a premium price, as indicated in step process proceeds to step 830. If the advertisement space level performance does not exceed the promise level of performance, a return to step 770 occurs.

Subsequent to steps 810, 820 and 830, where the web matching engine either charges, refunds or does not provide a buyer with a refund or other compensation, the matching engine displays tracking data related to the placed advertisement space, as indicated in step 840. Next, the web matching engine transmits the tracking data to the buyer for review, as indicated in step 850.

With reference to FIG. 10(e), after receiving tracking data, the buyer decides whether to modify an existing placement, as indicated in step 855. If the buyer decides to modify an existing ad placement, then modifications are performed, as indicated in step 860, and a return to step 500 of FIG. 9 occurs. If, however, the buyer decides not to modify an existing ad placement, the buyer then determines whether to add an additional advertisement space order, as indicated in step 870. If the buyer decides not to add another advertisement space, then the method is terminated. On the other hand, if the buyer decides to add another advertisement space, a return to step 315 of FIG. 7(a) occurs.

In an embodiment of the present principles, options such as pop up ads, streaming video, banners, key words, ads, billboards, radio, TV and DVD ads, are implemented. Here, the options are tracked via specific promotion codes or digital XML or HTML links, as well as via web services. The present principles contemplate that as more and more devices become wireless, it will be advantageous to configure these devices such that they may report interaction with users based on Bluetooth, radio frequency identification (RFID) or some other type of discovery between the users and ads.

In an alternative embodiment, a browser plug-in is used to provide a browser with the ability to disclose user information to a trusted (i.e., secure) web matching engine to better match the user's needs or search results. In accordance with a present contemplated embodiment, the web matching engine utilizes the user information to provide an optimal ranking of the sellers and to provide an optimal match between the buyers and sellers. Here, the matching engine may use third party consumer profiling companies such as Acxiom to allow extremely targeted marketing by combining personal and profiling information to produce optimized results for buyers. Moreover, sellers may trust the disclosure of their personal and confidential information to the central clearing facility, because the disclosed information is only used as an aggregate to improve the overall performance of the facility for all users.

The system and method of the present principles permits the creation of a market place for the transfer and distribution of information, and provides real-time market pricing for different sources of information and the price that different entities are willing to pay to tag, attach or advertise around such information. In addition, subscribers and publishers may use the information to sell content based on a pre-agreed price, while other subscribers may let the web matching engine automate and optimize their income based on current market prices.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A method for real-time placement of advertisements in a dynamic, real time environment between at least one advertisement space buyer, at least one advertisement space seller and at least one web matching engine, comprising the steps of:
receiving order information from at least one buyer for desired advertising space and seller offer information for advertising space from at least one seller at the at least one web matching engine;
sending information related to at least one match between the at least one buyer order information and the at least one seller offer information from the at least one web matching engine to at least one buyer for approval;
determining whether the at least one buyer approved the information related to the at least one match between the at least one buyer order information for desired advertising space and the at least one seller offer information for advertising space;
sending at least one buyer approval to the at least one web matching engine;
processing the at least one buyer approval and posting at least one approved advertisement on selected media;
analyzing information based on the at least one approved advertisement obtained from tracking agencies which track, rate and provide advertisement performance information to the web matching engine, said advertisement performance information representing an indication of an effectiveness of the advertisement to translate advertisement dollars into orders and revenue based on the at least one approved advertisement; and
providing the analyzed information to the at least one buyer so as to permit the at least one buyer to decide whether to add new advertisements or modify the at least one approved advertisement based on the effectiveness of the advertisement to translate advertising dollars to orders and revenues.

2. The method of claim 1, further comprising the step of:
determining whether at least one buyer decides to continue approving information related to at least one match between the at least one buyer order information and the at least one seller offer information.

3. The method of claim 2, further comprising the step of:
generating preliminary information about at least one desired advertising space.

4. The method of claim 1, wherein the at least one buyer sets at least one parameter associated with an advertisement.

5. The method of claim 4, wherein the at least one parameter comprises at least one of a dollar amount to be spent daily, an advertising medium used for the advertisement, a minimum conversion number, a scope of geographic coverage for the advertisement, a user profile and historical data and a maximum payment price for specific keywords.

6. The method of claim 1, wherein the at least one buyer designates at least one parameter associated with advertisement placement.

7. The method of claim 6, wherein the at least one parameter comprises at least one of when, how and based on what events to increase or decrease advertisement buying.

8. The method of claim 1, wherein the order information from at least one buyer includes bids for advertising space.

9. The method of claim 1, wherein the at least one seller generates at least one advertisement space and prepares advertisement packages for purchase of single or multiple mediums by at least one buyer.

10. The method of claim 9, wherein generation of the at least one advertising space and advertisement packages is performed using at least one of data from a database, seller inventory and competitor pricing that is based on information obtained from the central clearing facility and prior behavior patterns of the at least one buyer.

11. The method of claim 1, wherein said sending step includes the step of:
performing a search at the at least one web matching engine to locate the information related to the at least one match between the at least one buyer order information and the at least one seller offer information.

12. The method of claim 1, wherein the web matching engine processes information received from at least one buyer and at least one seller regarding parameters for at least one buyer order and at least one seller offer.

13. The method of claim 1, wherein the at least one buyer and at least one seller can view at least one of each other's actual listed prices, the actual prices listed by a system and third party conversion information related to each buyer.

14. The method of claim 2, further comprising the step of:
placing continuous limit orders with the web matching engine.

15. The method of claim 14, wherein the continuous limit orders comprise instructions for the web matching engine to maintain and place advertisements in different locations with at least one seller having a performance which exceeds a minimum requirement set by the at least one buyer.

16. The method of claim 15, wherein the web matching engine monitors all cost-per-click ads available and their pricing information and attempts to match the advertisements within a budget provided by the at least one buyer until the budget of the at least one buyer is spent.

17. The method of claim 1, wherein said analyzing step includes the steps of:
collecting transaction information from at least one applicable web or media servers and other third party tracking agencies;
posting at least one approved advertisement on selected media; and
reporting the performance of the at least one posted advertisement to at least a pricing database and the web matching engine.

18. The method of claim 15, further comprising the step of:
refunding the at least one buyer for advertisements having a performance which is below the minimum requirement set by the at least one buyer.

19. The method of claim 15, further comprising the step of:
charging the at least one buyer for advertisements having a performance which exceeds the minimum requirement set by the at least one buyer.

20. A system for permitting real-time placement of advertisements in a dynamic, real time environment between at least one advertisement space buyer and at least one advertisement space seller, comprising:
a web matching engine for receiving order information from at least one buyer for desired advertising space and seller offer information for advertising space from at least one seller, said web matching engine analyzing information based on at least one approved advertisement obtained from tracking agencies which track, rate and provide advertisement performance information to the web matching engine, said advertisement performance information representing an indication of an effectiveness of the advertisement to translate advertisement dollars into orders and revenue based on the at least one approved advertisement;
at least one buyer computing device coupled to the web matching engine via a first network for uploading order information from the at least one buyer;
at least one seller computing device coupled to the web matching engine via a second network;
a switch node indirectly coupled to the web matching engine;
at least one buyer content server, at least one seller content server and a content database and server, each of which are coupled to the switch node.

21. The system of claim 20, wherein the at least one buyer comprises advertisers or ad agencies.

22. The system of claim 20, wherein the web matching engine at least one of aggregates, sorts, ranks, attaches relevant information, publishes, bills, collects and make payments to receiving parties.

23. The system of claim 20, wherein the web matching engine is connected to the switch node via open source software.

24. The system of claim 20, wherein the at least one buyer computing device comprises at least one of computer, cell phone, personal digital assistant (PDA) or another web enabled device.

25. The system of claim 20, wherein the at least one buyer content servers interact with the switch node, which interacts with the at least one seller content servers and the central content database and server.

26. The system of claim 20, wherein the web matching engine sends information related to at least one match between the at least one buyer order information and the at least one seller offer information to the at least one buyer for approval.

27. The system of claim 26, wherein the web matching engine determines whether the at least one buyer approved the information related to the at least one match between the at least one buyer order information for desired advertising space and the at least one seller offer information for advertising space.

28. The system of claim 26 wherein the web matching engine receives at least one buyer approval, processes the at least one buyer approval and posts at least one approved advertisement on the selected media.

29. (canceled)

30. The system of claim 29, wherein the web matching engine provides the analyzed information to the at least one buyer so as to permit the at least one buyer to decide whether to add new advertisements or modify the at least one approved advertisement.
